(19) United States
(12) Patent Application Publication
(10) Pub. No.: US 2026/0019606 A1
(43) Pub. Date: Jan. 15, 2026

(54) DEEP DISTRIBUTION-AWARE POINT FEATURE EXTRACTOR FOR AI-BASED POINT CLOUD COMPRESSION

(71) Applicant: InterDigital VC Holdings, Inc., Wilmington, DE (US)

(72) Inventors: Junghyun Ahn, New York, NY (US); Jiahao Pang, Plainsboro, NJ (US); Muhammad Asad Lodhi, Highland Park, NJ (US); Dong Tian, Boxborough, MA (US)

(21) Appl. No.: 18/992,903

(22) PCT Filed: Jul. 11, 2023
(86) PCT No.: PCT/US2023/027424

§ 371 Date: Jan. 9, 2025

Related U.S. Application Data
(60) Provisional application No. 63/388,600, filed on Jul. 12, 2022.

(51) Int. Cl. H04N 19/42; H04N 19/136

(52) U.S. Cl. CPC H04N 19/42; H04N 19/136

(57) ABSTRACT

Some embodiments of a method may include a learning-based point cloud geometry processing block method, the method including: accessing a first feature map, wherein the first feature map has a quantity of C channels and is an input to the processing block, and wherein the first feature map is generated by a first set of neural network layers; accessing a set of distribution parameters; transforming the first feature map to a second feature map based on the set of distribution parameters; and encoding the second feature map into a bitstream. These example processes may be applicable to both the encoder and the decoder of an AI-based point cloud compression (PCC) framework.

### CROSS-REFERENCE TO RELATED APPLICATIONS

The present application is non-provisional filing of, and claims benefit under 35 U.S.C. § 119 (e) from, U.S. Provisional Patent Application Ser. No. 63/388,600, entitled “Deep Distribution-Aware Point Feature for AI-Based Point Cloud Compression” and filed Jul. 12, 2022 (“600 application”), which is hereby incorporated by reference in its entirety. The following cases are incorporated by reference in their entirety: U.S. Provisional Patent Application Ser. No. 63/252,482, entitled “Method and Apparatus for Point Cloud Compression Using Hybrid Deep Entropy Coding” and filed Oct. 5, 2021 (“482 application”); U.S. Provisional Patent Application Ser. No. 63/297,894, entitled “Coordinate Refinement and Upsampling from Quantized Point Cloud Reconstruction” and filed Jan. 10, 2022 (“894 application”); and U.S. Provisional Patent Application Ser. No. 63/297,869, entitled “Scalable Framework for Point Cloud Compression” and filed Jan. 10, 2022 (“869 application”).

### BACKGROUND

Point clouds are data that may be used in numerous business domains, such as autonomous driving, robotics, AR/VR, civil engineering, computer graphics, to the animation/movie industry. 3D LiDAR sensors have been deployed in self-driving cars, and affordable LiDAR sensors include Velodyne Velabit, Apple iPad Pro 2020, and Intel RealSense LiDAR camera L515. With advances in sensing technologies, 3D point cloud data is becoming more widespread, such as in the applications and industries mentioned above.

### SUMMARY

An example learning-based point cloud geometry processing block method in accordance with some embodiments may include: accessing a first feature map, wherein the first feature map has a quantity of C channels and is an input to the processing block, and wherein the first feature map is generated by a first set of neural network layers; accessing a set of distribution parameters; transforming the first feature map to a second feature map based on the set of distribution parameters; and encoding the second feature map into a bitstream,

Some embodiments of the example learning-based point cloud geometry encoding block method may further include updating the first feature map by normalizing elements of the first feature map.

For some embodiments of the example learning-based point cloud geometry encoding block method, normalizing the elements of the first feature map may include: determining a respective length of each feature vector associated with one of the elements of the first feature map; and dividing each element of the first feature map by the respective length.

For some embodiments of the example learning-based point cloud geometry encoding block method, normalizing the elements of the first feature map may include: arranging each of one of more vectors by reshaping an associated feature channel in the first feature map; determining a respective length of each of the one or more vectors for each feature channel; and dividing each vector element of each vector by the respective length for each feature channel, wherein each vector element is one of the elements of the first feature map.

For some embodiments of the example learning-based point cloud geometry encoding block method, normalizing the elements of the first feature map may include: arranging each of one of more vectors by reshaping an associated feature channel in the first feature map; determining a respective standard deviation of each of the one or more vectors for each feature channel; and determining a respective mean of each of the one or more vectors for each feature channel; and updating each vector element of each vector by subtracting the respective mean; and dividing each updated vector element of each vector by the respective standard deviation for each feature channel, wherein each vector element is one of the elements of the first feature map.

For some embodiments of the example learning-based point cloud geometry encoding block method, the set of distribution parameters is determined using a back-propagation technique during a training period.

For some embodiments of the example learning-based point cloud geometry encoding block method, the set of distribution parameters is determined on a per feature channel basis.

Some embodiments of the example learning-based point cloud geometry encoding block method may further include: updating the second feature map by performing downsampling using a function of average pooling or max pooling.

Some embodiments of the example learning-based point cloud geometry encoding block method may further include: determining a third feature map by filtering the second feature map using a smoothing filter; and updating the second feature map by concatenating the third feature map to the second feature map.

For some embodiments of the example learning-based point cloud geometry encoding block method, prior to encoding the second feature map, performing a process may include: accessing a second set of distribution parameters; and updating the second feature map by transforming the second feature map based on the second set of distribution parameters.

For some embodiments of the example learning-based point cloud geometry encoding block method, prior to encoding the second feature map, performing a process may include aggregating the second feature map using a second neural network.

For some embodiments of the example learning-based point cloud geometry encoding block method, the second neural network is selected from the group consisting of a sparse convolutional neural network (CNN) and multi-perceptron layers (MLP).

For some embodiments of the example learning-based point cloud geometry encoding block method, aggregating the second feature map may include using a Residual Network (ResNet) architecture.

Some embodiments of the example learning-based point cloud geometry encoding block method may further include: determining a fourth feature map by aggregating the first feature map using a neural network in parallel to transforming the first feature map to the second feature map; and updating the second feature map by concatenating the fourth feature map to the second feature map.

For some embodiments of the example learning-based point cloud geometry encoding block method, aggregating the first feature map using the neural network may include using a Residual Network (ResNet) architecture.

For some embodiments of the example learning-based point cloud geometry encoding block method, prior to transforming the first feature map to the second feature map, performing a process including aggregating the first feature map using a third neural network.

For some embodiments of the example learning-based point cloud geometry encoding block method, the third neural network is selected from the group consisting of a sparse convolutional neural network (CNN) and multi-perceptron layers (MLP).

An example learning-based point cloud geometry encoding block apparatus in accordance with some embodiments may include: a processor; and a non-transitory computer-readable medium storing instructions operative, when executed by the processor, to cause the apparatus to perform any of the claims listed above

An example learning-based point cloud geometry decoder method in accordance with some embodiments may include: decoding a first feature map from a bitstream; accessing a set of distribution parameters; transforming the first feature map to a second feature map based on the set of distribution parameters; and reconstructing the point cloud from the second feature map.

Some embodiments of the example learning-based point cloud geometry decoder method may further include: updating the first feature map by normalizing elements of the first feature map.

For some embodiments of the example learning-based point cloud geometry decoder method, normalizing the elements of the first feature map may include: determining a respective length of each feature vector associated with one of the elements of the first feature map; and dividing each element of the first feature map by the respective length.

For some embodiments of the example learning-based point cloud geometry decoder method, normalizing the elements of the first feature map may include: arranging each of one of more vectors by reshaping an associated feature channel in the first feature map; determining a respective length of each of the one or more vectors for each feature channel; and dividing each vector element of each vector by the respective length for each feature channel, wherein each vector element is one of the elements of the first feature map.

For some embodiments of the example learning-based point cloud geometry decoder method, normalizing the elements of the first feature map may include: arranging each of one of more vectors by reshaping an associated feature channel in the first feature map; determining a respective standard deviation of each of the one or more vectors for each feature channel; and determining a respective mean of each of the one or more vectors for each feature channel; and updating each vector element of each vector by subtracting the respective mean; and dividing each updated vector element of each vector by the respective standard deviation for each feature channel, wherein each vector element is one of the elements of the first feature map.

For some embodiments of the example learning-based point cloud geometry decoder method, the set of distribution parameters is determined using a back-propagation technique during a training period.

For some embodiments of the example learning-based point cloud geometry decoder method, the set of distribution parameters is determined on a per feature channel basis.

For some embodiments of the example learning-based point cloud geometry decoder method, prior to encoding the second feature map, performing a process including: accessing a second set of distribution parameters; and updating the second feature map by transforming the second feature map based on the second set of distribution parameters.

For some embodiments of the example learning-based point cloud geometry decoder method, prior to encoding the second feature map, performing a process including aggregating the second feature map using a second neural network.

For some embodiments of the example learning-based point cloud geometry decoder method, the second neural network is selected from the group consisting of a sparse convolutional neural network (CNN) and multi-perceptron layers (MLP).

For some embodiments of the example learning-based point cloud geometry decoder method, aggregating the second feature map may include using a Residual Network (ResNet) architecture.

For some embodiments of the example learning-based point cloud geometry decoder method, prior to transforming the first feature map to the second feature map, performing a process including aggregating the first feature map using a third neural network.

For some embodiments of the example learning-based point cloud geometry decoder method, the third neural network is selected from the group consisting of a sparse convolutional neural network (CNN) and multi-perceptron layers (MLP).

An example learning-based point cloud geometry decoder apparatus in accordance with some embodiments may include: a processor; and a non-transitory computer-readable medium storing instructions operative, when executed by the processor, to cause the apparatus to perform any of the methods listed above.

Embodiments described herein include methods that are used in video encoding and decoding (collectively “coding”).

In additional embodiments, encoder and decoder apparatus are provided to perform the methods described herein. An encoder or decoder apparatus may include a processor configured to perform the methods described herein. The apparatus may include a computer-readable medium (e.g. a non-transitory medium) storing instructions for performing the methods described herein. In some embodiments, a computer-readable medium (e.g. a non-transitory medium) stores a video encoded using any of the methods described herein.

One or more of the present embodiments also provide a computer readable storage medium having stored thereon instructions for performing bi-directional optical flow, encoding or decoding video data according to any of the methods described above. The present embodiments also provide a computer readable storage medium having stored thereon a bitstream generated according to the methods described above. The present embodiments also provide a method and apparatus for transmitting the bitstream generated according to the methods described above. The present embodiments also provide a computer program product including instructions for performing any of the methods described.

### BRIEF DESCRIPTION OF THE DRAWINGS

FIG. 1A is a system diagram illustrating an example communications system according to some embodiments.

FIG. 1B is a system diagram illustrating an example wireless transmit/receive unit (WTRU) that may be used within the communications system illustrated in FIG. 1A according to some embodiments.

FIG. 1C is a functional block diagram of a system according to some embodiments.

FIG. 2A is a functional block diagram of block-based video encoder, such as an encoder used for Versatile Video Coding (VVC), according to some embodiments.

FIG. 2B is a functional block diagram of a block-based video decoder, such as a decoder used for VVC, according to some embodiments.

FIG. 3 is a functional block diagram illustrating an example encoder architecture for point cloud (PC) feature extraction according to some embodiments.

FIG. 4 is a functional block diagram illustrating an example of how a PC group size K may be decided for a given voxel quantization for PC reconstruction in a point cloud compression (PCC) framework according to some embodiments.

FIG. 5 is a functional block diagram illustrating an example point-wise feature extraction according to some embodiments.

FIG. 6 is a functional block diagram illustrating an example group feature distribution tensor according to some embodiments.

FIG. 7 is a functional block diagram illustrating an example group feature distribution with learnable transform parameters according to some embodiments.

FIG. 8 is a functional block diagram illustrating an example transformed feature aggregation, augmentation, and dimension matching according to some embodiments.

FIG. 9 is a functional block diagram illustrating an example point-wise residual feature extraction and group-wise feature aggregation and augmentation according to some embodiments.

FIG. 10 is a functional block diagram illustrating an example encoder architecture for PC feature extraction according to some embodiments.

FIG. 11 is a functional block diagram illustrating an example decoder architecture according to some embodiments.

FIG. 12A is a functional block diagram illustrating an encoder and a decoder in an autoencoder-based lossy geometry compression.

FIG. 12B is a functional block diagram illustrating an example application of a PCC framework to an encoder and a decoder in an autoencoder-based lossy geometry compression according to some embodiments.

FIG. 13A is a functional block diagram illustrating a point analysis and point synthesis within a scalable PCC framework.

FIG. 13B is a functional block diagram illustrating an example application of a PCC framework to a point analysis and point synthesis within a scalable PCC framework according to some embodiments.

FIG. 14A is a functional block diagram illustrating a set abstraction (SA) process in a PointContextNet environment.

FIG. 14B is a functional block diagram illustrating an example application of a PCC framework to a set abstraction (SA) process in a PointContextNet environment according to some embodiments.

FIG. 15A is a functional block diagram illustrating a set abstraction (SA) process in a coordinate refinement module (CRM).

FIG. 15B is a functional block diagram illustrating an example application of a PCC framework to a set abstraction (SA) process in a coordinate refinement module (CRM) according to some embodiments.

FIG. 16 is a flowchart illustrating an example process for point cloud feature extraction according to some embodiments.

FIG. 17 is a functional block diagram illustrating a deep-feature-based PCC pipeline according to some embodiments.

FIG. 18 is a functional block diagram illustrating a DDA-Net encoder architecture according to some embodiments.

FIG. 19 is a functional block diagram illustrating a probability estimator distribution network according to some embodiments.

FIG. 20 is a flowchart illustrating an example process for point cloud feature extraction according to some embodiments.

FIG. 21 is a flowchart illustrating an example process for point cloud feature extraction according to some embodiments.

FIG. 22 is a flowchart illustrating an example learning-based point cloud geometry process according to some embodiments.

FIG. 23 is a flowchart illustrating an example learning-based point cloud geometry process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . .” For brevity and clarity of presentation, this implied leading clause is not repeated ad nauseum in the detailed description.

### DETAILED DESCRIPTION

### Example Networks for Implementation of Embodiments

A wireless transmit/receive unit (WTRU) may be used, e.g., to perform a point cloud (PC) extraction in some embodiments described herein.

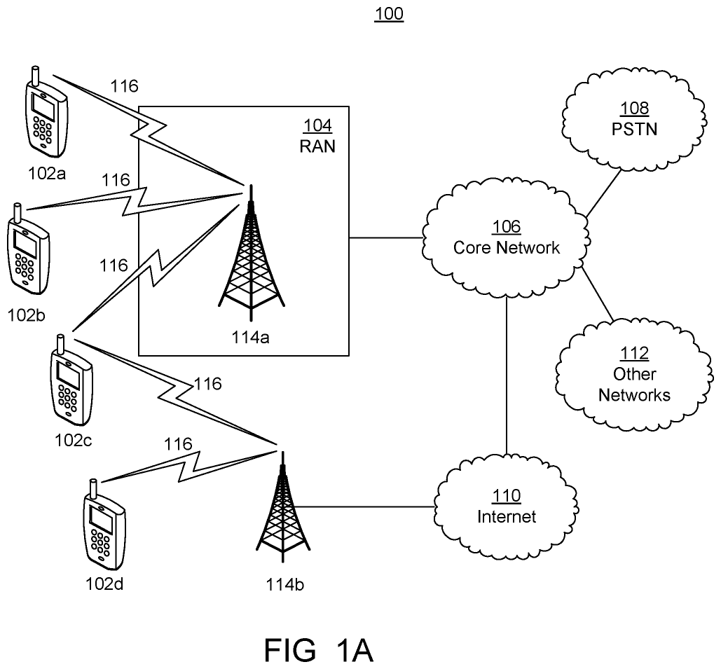

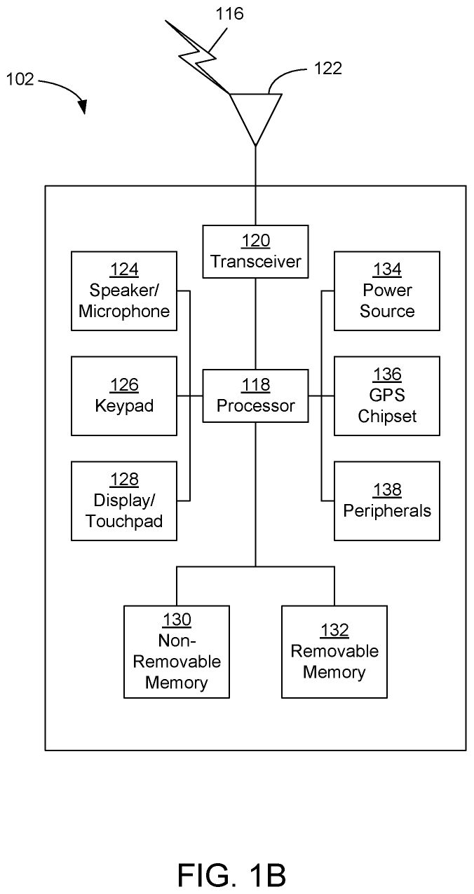

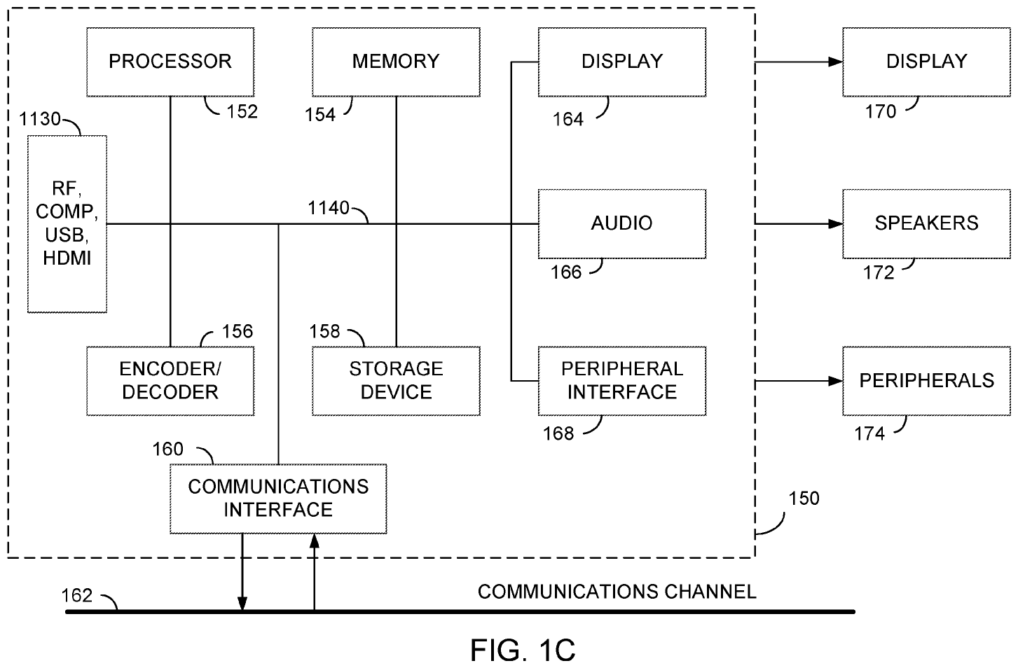

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104/113 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106 may be in direct or indirect communication with other RANs that employ the same RAT as the RAN 104/113 or a different RAT. For example, in addition to being connected to the RAN 104/113, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

Although the WTRU is described in FIGS. 1A-1B as a wireless terminal, it is contemplated that in certain representative embodiments that such a terminal may use (e.g., temporarily or permanently) wired communication interfaces with the communication network.

In representative embodiments, the other network 112 may be a WLAN.

In view of FIGS. 1A-1B, and the corresponding description, one or more, or all, of the functions described herein may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Example Systems

The embodiments described herein are not limited to being implemented on a WTRU. Such embodiments may be implemented using other systems, such as the system of FIG. 1C. FIG. 1C is a block diagram of an example of a system in which various aspects and embodiments are implemented. System 150 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 150, singly or in combination, can be embodied in a single integrated circuit (IC), multiple ICs, and/or discrete components. For example, in at least one embodiment, the processing and encoder/decoder elements of system 150 are distributed across multiple ICs and/or discrete components. In various embodiments, the system 150 is communicatively coupled to one or more other systems, or other electronic devices, via, for example, a communications bus or through dedicated input and/or output ports. In various embodiments, the system 150 is configured to implement one or more of the aspects described in this document.

The system 150 includes at least one processor 152 configured to execute instructions loaded therein for implementing, for example, the various aspects described in this document. Processor 152 can include embedded memory, input output interface, and various other circuitries as known in the art. The system 150 includes at least one memory 154 (e.g., a volatile memory device, and/or a non-volatile memory device). System 150 includes a storage device 158, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 158 can include an internal storage device, an attached storage device (including detachable and non-detachable storage devices), and/or a network accessible storage device, as non-limiting examples.

System 150 includes an encoder/decoder module 156 configured, for example, to process data to provide an encoded video or decoded video, and the encoder/decoder module 156 can include its own processor and memory. The encoder/decoder module 156 represents module(s) that can be included in a device to perform the encoding and/or decoding functions. As is known, a device can include one or both of the encoding and decoding modules. Additionally, encoder/decoder module 156 can be implemented as a separate element of system 150 or can be incorporated within processor 152 as a combination of hardware and software as known to those skilled in the art.

Program code to be loaded onto processor 152 or encoder/decoder 156 to perform the various aspects described in this document can be stored in storage device 158 and subsequently loaded onto memory 154 for execution by processor 152. In accordance with various embodiments, one or more of processor 152, memory 154, storage device 158, and encoder/decoder module 156 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 152 and/or the encoder/decoder module 156 is used to store instructions and to provide working memory for processing that is needed during encoding or decoding. In other embodiments, however, a memory external to the processing device (for example, the processing device can be either the processor 152 or the encoder/decoder module 156) is used for one or more of these functions. The external memory can be the memory 154 and/or the storage device 158, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 150 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 150 to other electronic devices across USB and/or HDMI connections. It is to be understood that various aspects of input processing, for example, Reed-Solomon error correction, can be implemented, for example, within a separate input processing IC or within processor 152 as necessary. Similarly, aspects of USB or HDMI interface processing can be implemented within separate interface ICs or within processor 152 as necessary. The demodulated, error corrected, and demultiplexed stream is provided to various processing elements, including, for example, processor 152, and encoder/decoder 156 operating in combination with the memory and storage elements to process the datastream as necessary for presentation on an output device.

Various elements of system 150 can be provided within an integrated housing. Within the integrated housing, the various elements can be interconnected and transmit data therebetween using suitable connection arrangement 1140, for example, an internal bus as known in the art, including the Inter-IC (12C) bus, wiring, and printed circuit boards.

The system 150 includes communication interface 160 that enables communication with other devices via communication channel 162. The communication interface 160 can include, but is not limited to, a transceiver configured to transmit and to receive data over communication channel 162. The communication interface 160 can include, but is not limited to, a modem or network card and the communication channel 162 can be implemented, for example, within a wired and/or a wireless medium.

Data is streamed, or otherwise provided, to the system 150, in various embodiments, using a wireless network such as a Wi-Fi network, for example IEEE 802.11 (IEEE refers to the Institute of Electrical and Electronics Engineers). The Wi-Fi signal of these embodiments is received over the communications channel 162 and the communications interface 160 which are adapted for Wi-Fi communications. The communications channel 162 of these embodiments is typically connected to an access point or router that provides access to external networks including the Internet for allowing streaming applications and other over-the-top communications. Other embodiments provide streamed data to the system 150 using a set-top box that delivers the data over the HDMI connection of the input block 1130. Still other embodiments provide streamed data to the system 150 using the RF connection of the input block 1130. As indicated above, various embodiments provide data in a non-streaming manner. Additionally, various embodiments use wireless networks other than Wi-Fi, for example a cellular network or a Bluetooth network.

The system 150 can provide an output signal to various output devices, including a display 170, speakers 172, and other peripheral devices 174. The display 170 of various embodiments includes one or more of, for example, a touchscreen display, an organic light-emitting diode (OLED) display, a curved display, and/or a foldable display. The display 170 can be for a television, a tablet, a laptop, a cell phone (mobile phone), or other device. The display 170 can also be integrated with other components (for example, as in a smart phone), or separate (for example, an external monitor for a laptop). The other peripheral devices 174 include, in various examples of embodiments, one or more of a stand-alone digital video disc (or digital versatile disc) (DVR, for both terms), a disk player, a stereo system, and/or a lighting system. Various embodiments use one or more peripheral devices 174 that provide a function based on the output of the system 150. For example, a disk player performs the function of playing the output of the system 150.

In various embodiments, control signals are communicated between the system 150 and the display 170, speakers 172, or other peripheral devices 174 using signaling such as AV.Link, Consumer Electronics Control (CEC), or other communications protocols that enable device-to-device control with or without user intervention. The output devices can be communicatively coupled to system 150 via dedicated connections through respective interfaces 164, 166, and 168. Alternatively, the output devices can be connected to system 150 using the communications channel 162 via the communications interface 160. The display 170 and speakers 172 can be integrated in a single unit with the other components of system 150 in an electronic device such as, for example, a television. In various embodiments, the display interface 164 includes a display driver, such as, for example, a timing controller (T Con) chip.

The display 170 and speaker 172 can alternatively be separate from one or more of the other components, for example, if the RF portion of input 1130 is part of a separate set-top box. In various embodiments in which the display 170 and speakers 172 are external components, the output signal can be provided via dedicated output connections, including, for example, HDMI ports, USB ports, or COMP outputs.

The embodiments can be carried out by computer software implemented by the processor 152 or by hardware, or by a combination of hardware and software. As a non-limiting example, the embodiments can be implemented by one or more integrated circuits. The memory 154 can be of any type appropriate to the technical environment and can be implemented using any appropriate data storage technology, such as optical memory devices, magnetic memory devices, semiconductor-based memory devices, fixed memory, and removable memory, as non-limiting examples. The processor 152 can be of any type appropriate to the technical environment, and can encompass one or more of microprocessors, general purpose computers, special purpose computers, and processors based on a multi-core architecture, as non-limiting examples.

### Block-Based Video Coding

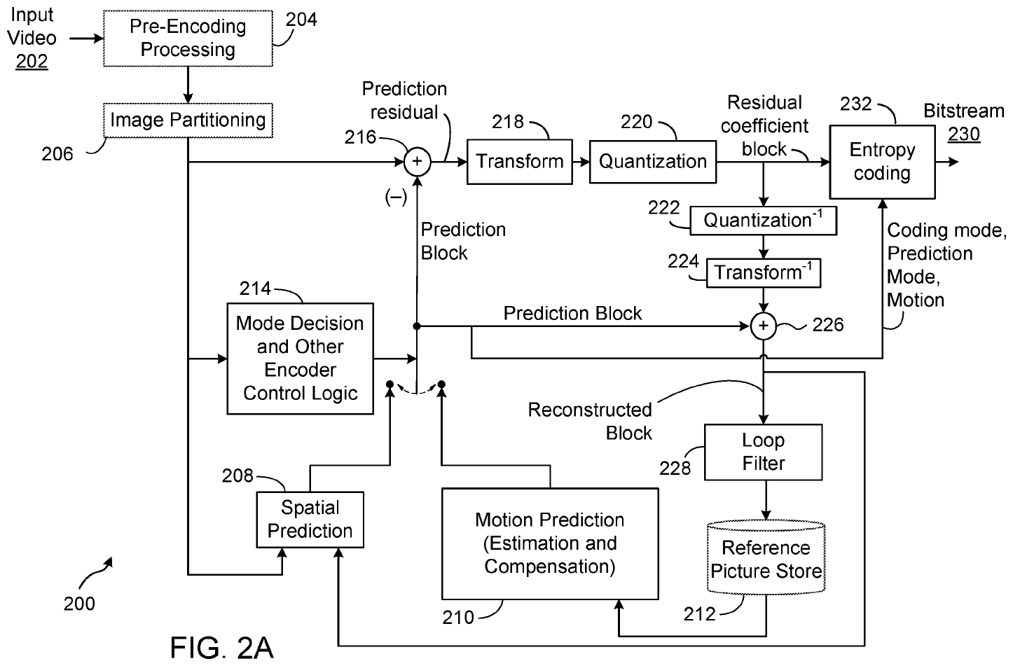

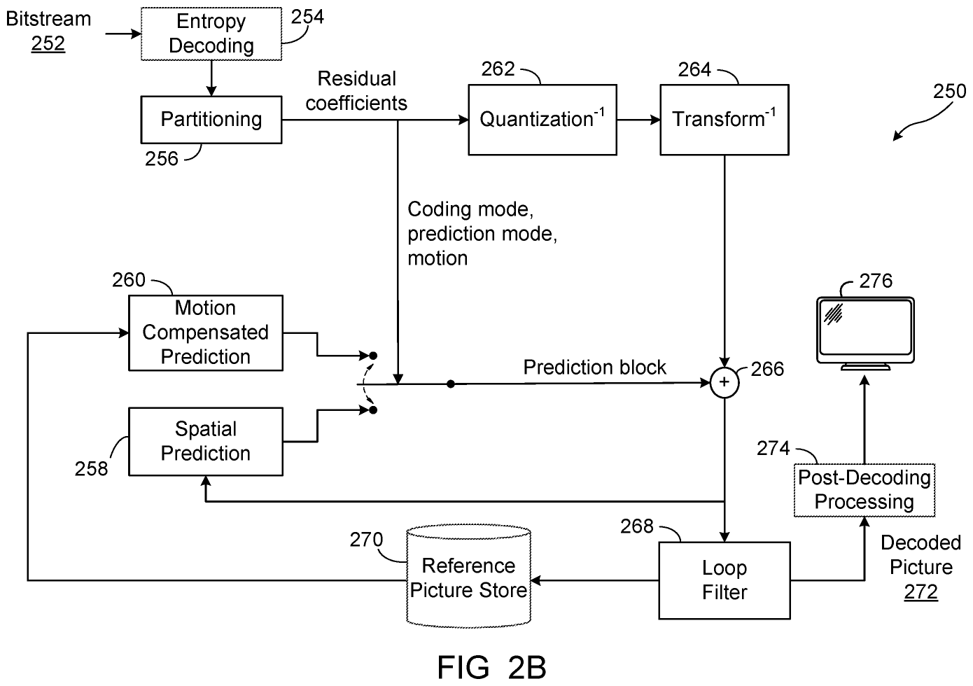

Like HEVC, the WVC is built upon the block-based hybrid video coding framework. FIG. 2A gives the block diagram of a block-based hybrid video encoding system 200. Variations of this encoder 200 are contemplated, but the encoder 200 is described below for purposes of clarity without describing all expected variations.

Before being encoded, a video sequence may go through pre-encoding processing (204), for example, applying a color transform to an input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

The input video signal 202 including a picture to be encoded is partitioned (206) and processed block by block in units of, for example, CUs. Different CUs may have different sizes. In VTM-1.0, a CU can be up to 128×128 pixels. However, different from the HEVC which partitions blocks only based on quad-trees, in the VTM-1.0, a coding tree unit (CTU) is split into CUs to adapt to varying local characteristics based on quad/binary/ternary-tree. Additionally, the concept of multiple partition unit type in the HEVC is removed, such that the separation of CU, prediction unit (PU) and transform unit (TU) does not exist in the VVC-1.0 anymore; instead, each CU is always used as the basic unit for both prediction and transform without further partitions. In the multi-type tree structure, a CTU is firstly partitioned by a quad-tree structure. Then, each quad-tree leaf node can be further partitioned by a binary and ternary tree structure. Different splitting types may be used, such as quaternary partitioning, vertical binary partitioning, horizontal binary partitioning, vertical ternary partitioning, and horizontal ternary partitioning.

In the encoder of FIG. 2A, spatial prediction (208) and/or temporal prediction (210) may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. A temporal prediction signal for a given CU may be signaled by one or more motion vectors (MVs) which indicate the amount and the direction of motion between the current CU and its temporal reference. Also, if multiple reference pictures are supported, a reference picture index may additionally be sent, which is used to identify from which reference picture in the reference picture store (212) the temporal prediction signal comes.

The mode decision block (214) in the encoder chooses the best prediction mode, for example based on a rate-distortion optimization method. This selection may be made after spatial and/or temporal prediction is performed. The intra/inter decision may be indicated by, for example, a prediction mode flag. The prediction block is subtracted from the current video block (216) to generate a prediction residual. The prediction residual is de-correlated using transform (218) and quantized (220). (For some blocks, the encoder may bypass both transform and quantization, in which case the residual may be coded directly without the application of the transform or quantization processes.) The quantized residual coefficients are inverse quantized (222) and inverse transformed (224) to form the reconstructed residual, which is then added back to the prediction block (226) to form the reconstructed signal of the CU. Further in-loop filtering, such as deblocking/SAO (Sample Adaptive Offset) filtering, may be applied (228) on the reconstructed CU to reduce encoding artifacts before it is put in the reference picture store (212) and used to code future video blocks. To form the output video bit-stream 230, coding mode (inter or intra), prediction mode information, motion information, and quantized residual coefficients are all sent to the entropy coding unit (108) to be further compressed and packed to form the bit-stream.

FIG. 2B gives a block diagram of a block-based video decoder 250. In the decoder 250, a bitstream is decoded by the decoder elements as described below. Video decoder 250 generally performs a decoding pass reciprocal to the encoding pass as described in FIG. 2A. The encoder 200 also generally performs video decoding as part of encoding video data.

In particular, the input of the decoder includes a video bitstream 252, which can be generated by video encoder 200. The video bit-stream 252 is first unpacked and entropy decoded at entropy decoding unit 254 to obtain transform coefficients, motion vectors, and other coded information. Picture partition information indicates how the picture is partitioned. The decoder may therefore divide (256) the picture according to the decoded picture partitioning information. The coding mode and prediction information are sent to either the spatial prediction unit 258 (if intra coded) or the temporal prediction unit 260 (if inter coded) to form the prediction block. The residual transform coefficients are sent to inverse quantization unit 262 and inverse transform unit 264 to reconstruct the residual block. The prediction block and the residual block are then added together at 266 to generate the reconstructed block. The reconstructed block may further go through in-loop filtering 268 before it is stored in reference picture store 270 for use in predicting future video blocks.

The decoded picture 272 may further go through post-decoding processing (274), for example, an inverse color transform (e.g. conversion from YCbCr 4:2:0 to RGB 4:4:4) or an inverse remapping performing the inverse of the remapping process performed in the pre-encoding processing (204). The post-decoding processing can use metadata derived in the pre-encoding processing and signaled in the bitstream. The decoded, processed video may be sent to a display device 276. The display device 276 may be a separate device from the decoder 250, or the decoder 250 and the display device 276 may be components of the same device.

Various methods and other aspects described in this disclosure can be used to modify modules of a video encoder 200 or decoder 250. Moreover, the systems and methods disclosed herein are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this disclosure can be used individually or in combination.

This disclosure discusses point cloud compression and processing, which may include tools for compression, analysis, interpolation, representation and understanding of point cloud signals.

Point cloud data likely consumes a large portion of network traffic, e.g., among connected cars over 5G network and immersive communications (VR/AR/MR). Efficient representation formats may be used for point cloud communication. In particular, raw point cloud data may be organized and processed for modeling and sensing, such as the world, an environment, or a scene. Compression on raw point clouds may be used for storage and transmission of the data.

Furthermore, point clouds may represent a sequential scan of a scene, which may contain multiple moving objects. Such point clouds are called dynamic point clouds as compared to static point clouds, which may be captured from a static scene and/or static objects. Dynamic point clouds may be organized into frames, with different frames being captured at different times. Processing and compression of dynamic point clouds may be performed in real-time or with a low amount of delay.

The automotive industry, including autonomous vehicles, for example, may use point clouds. Autonomous cars “probe” their environment to make driving decisions based on their immediate surroundings. Typically, LiDAR sensors produce (dynamic) point clouds that are used by a perception engine. Furthermore, typically, these point clouds are dynamic with a high capture frequency, sparse, not necessarily colored, and not viewed by human eyes. Such point clouds may include other attributes, such as the reflectance ratio provided by the LiDAR which may be indicative of the material of a sensed object and may be used in making a decision.

Virtual Reality (VR) and immersive worlds have become a hot topic and are foreseen by many as the future of 2D flat video. The viewer may be immersed in an all-around environment, as opposed to standard TV where the viewer only looks at a virtual world in front of the viewer. There are several gradations in the immersivity depending on the freedom of the viewer in the environment. Point cloud formats may be used to distribute VR worlds and environment data. Such point clouds may be static or dynamic and are typically average size, such as less than several millions of points at a time.

Point clouds also may be used for various other purposes, such as scanning of cultural heritage objects and/or buildings in which objects such as statues or buildings are scanned in 3D. The spatial configuration data of the object may be shared without sending or visiting the actual object or building. Also, this data may be used to preserve knowledge of the object in case the object or building is destroyed, such as a temple by an earthquake. Such point clouds, typically, are static, colored, and huge in size.

Another use case is in topography and cartography using 3D representations, in which maps are not limited to a plane and may include the relief. Google Maps, for example, may use meshes instead of point clouds for their 3D maps. Nevertheless, point clouds may be a suitable data format for 3D maps, and such point clouds, typically, are also static, colored, and huge in size.

World modeling and sensing via point clouds may allow machines to record and use spatial configuration data about the 3D world around them, which may be used in the applications discussed above.

3D point cloud data include discrete samples of surfaces of objects or scenes. To fully represent the real world with point samples, a huge number of points may be used. For instance, a typical VR immersive scene includes millions of points, while point clouds typically may include hundreds of millions of points. Therefore, the processing of such large-scale point clouds is computationally expensive, especially for consumer devices, e.g., smartphones, tablets, and automotive navigation systems, which may have limited computational power.

Any processing or inference of the point cloud may use efficient storage methodologies. To store and process the input point cloud with affordable computational cost, the input point cloud may be down-sampled, in which the down-sampled point cloud summarizes the geometry of the input point cloud while having much fewer points. The down-sampled point cloud is inputted into a subsequent machine task for further processing. However, further reduction in storage space may be achieved by converting raw point cloud data (original or down-sampled) into a bitstream through entropy coding techniques for lossless compression.

In addition to lossless coding, many scenarios use lossy coding to significantly improve compression ratio(s) while maintaining the induced distortion under certain quality levels. To achieve a less lossy coding, an efficient point feature extractor may be used to improve the accuracy of the reconstruction within the given resource budget.

Several articles indicate an interest in applying sparse convolution, which include Graham, Benjamin, Sparse 3D Convolutional Neural Networks, ARXIV PREPRINT, arXiv: 1505.02890 (2015); Liu, Baoyuan, et al., Sparse Convolutional Neural Networks, PROC. OF THE IEEE CONFERENCE ON COMPUTER VISION AND PATTERN RECOGNITION 806-814 (2015); Graham, Benjamin, et. al., 3D Semantic Segmentation with Submanifold Sparse Convolutional Networks, PROC. OF THE IEEE CONFERENCE ON COMPUTER VISION AND PATTERN RECOGNITION 9224-9232 (2018); and Choy, Christopher, et. al., 4D Spatio-Temporal Convnets: Minkowski Convolutional Neural Networks, PROC. OF THE IEEE CONFERENCE ON COMPUTER VISION AND PATTERN RECOGNITION 3075-3084 (2019). Along with these articles, point feature extraction from point cloud (PC) data is used in artificial intelligence (AI)-based PC analysis, such as classification, segmentation, registration, and compression. Point cloud compression (PCC) in such applications may use a trade-off between complexity (e.g., computational cost or storage consumption) and performance (e.g., accuracy) for PC reconstruction and a balanced architecture between the encoder and decoder.

A local group analysis may allow extraction of more representative features, but the method should not be too complex due to the encoding and decoding times in a PCC framework. Moreover, a point feature extractor should allow a deeper architecture without largely increasing the feature dimension because storage capacity may be limited.

Recent AI-based end-to-end frameworks and deep entropy models for point cloud compression (PCC) focus highly on the application of sparse voxel convolution and focus less on the point-based feature extraction from point cloud data. Point-wise feature analysis may play more of a role as the bit depth of input data increases. Moreover, geometric representation of point clouds affects the ability to efficiently decompress highly abstracted features to a lower bitrate without a large computation cost. An efficient AI-based feature extractor for PCC may be used as such point cloud datasets continue to grow.

The article Qi, Charles R., et al., Pointnet: Deep Learning on Point Sets for 3D Classification and Segmentation, PROC. OF THE IEEE CONFERENCE ON COMPUTER VISION AND PATTERN RECOGNITION 652-660 (2017) discusses a PointNet architecture with regard to a point-based feature extractor. The PointNet architecture consists of a series of point-wise fully connected multi-layer perceptron (MLP) layers with a certain feature dimension, then proceeds a pooling on all points. The PointNet architecture lacks feature details, such as local geometric information.

The PointNet++ architecture, which is described in Qi, Charles R., et al., Pointnet++: Deep Hierarchical Feature Learning on Point Sets in a Metric Space, ADVANCES IN NEURAL INFORMATION PROCESSING SYSTEMS 30 (2017), was introduced with a set abstraction layer within the architecture. This architecture exploits the local geometric information hierarchically, however, each sampling process requires samplings, such as farthest point samplings, followed by grouping functions, such as ball queries. Also, a mini PointNet needs to be run for each set abstraction layer, which may require some computation cost.

The above PointNet and PointNet++ methods extract features from given discrete point locations. To generalize this problem, points from a 3D space are randomly sampled and a function is then approximated to give a probability of point occupancy in any given coordinate in the 3D space. In article Mescheder, Lars, et al., Occupancy Networks: Learning 3D Reconstruction in Function Space, PROC. OF THE IEEE/CVF CONFERENCE ON COMPUTER VISION AND PATTERN RECOGNITION 4460-4470 (2019), occupancy networks try to learn this non-discrete function with the help of conditional batch normalization parameters fed on each corresponding step of the occupancy probability generator. To better extract the fine detail of the surface of points, article Peng, Songyou, et al., Convolutional Occupancy Networks, EUROPEAN CONFERENCE ON COMPUTER VISION 523-540 (2020) mentions that the occupancy networks are further improved by adding a U-Net-like convolution layer before the fully connected layer. Again, these methods are overly-complex and may be difficult to be deployed in a PCC framework. Article Ma, Xu, et al., Rethinking Network Design and Local Geometry in Point Cloud: A Simple Residual MLP Framework, ARXIV PREPRINT arXiv:2202.07123 (2022) discusses a PointMLP architecture. Article Ran, Haoxi, et al., Surface Representation for Point Clouds, ARXIV PREPRINT arXiv:2205.05740 (2022) discusses a RepSurf architecture. These architectures are introduced to improve the set abstraction layer. The PointMLP architecture introduces a hierarchical multi-stage architecture with an affine local geometry extractor. The RepSurf architecture adds local information to the point cloud data, such as triangle and umbrella orientations. All of these methods need multi-stage sampling and grouping processes, which are costly.

The above approaches target point cloud classification or segmentation problems. They are not fully suitable for a PCC framework due to the trade-off between accuracy and complexity. Moreover, the optimizing loss functions formulated for the PCC (rate and distortion) are different from the ones used for classification problems (cross-entropy).

Article Yan, Wei, et al., Deep Autoencoder-Based Lossy Geometry Compression for Point Clouds, ARXIV PREPRINT arXiv:1905.03691 (2019) (“Yan”) introduces an autoencoder-based PCC network. An MLP with an aggregation layer is abstracted for a global feature that is eventually sent to the entropy encoder. On the decoder side, the decoded feature code is inputted into an MLP decoder, and the point cloud is reconstructed. Based on a PointNet network, Yan applies an example point feature extractor within an end-to-end PCC framework.

'The 482 application describes, for example, a PointContextNet algorithm, while the '894 application describes, for example, a coordinate refinement module (CRM) algorithm. Both the '482 application and the '894 application use their respective example algorithms for, for example, deep entropy coding within an end-to-end (AI-based) PCC network to, e.g., apply a series of set abstraction (SA) layers with (costly) sampling and grouping of layers with hierarchical point feature analysis.

The '869 application introduces, for example, a scalable PCC framework by implementing feature extractors (in both encoder and decoder) with sparse convolution networks. For example, the feature extractor in this end-to-end framework processes the local point group information by integrating a K-nearest-neighbor oriented analysis for each point. The micro architecture used in some examples may be enhanced in the area of feature extraction.

The present application introduces, in accordance with some embodiments, a series of point cloud (PC) feature processes that take 3D points or features as an input and that extract group-wise feature points at the encoder output for some embodiments. While such an architecture may fit into any point cloud feature extraction for various purposes, such as, e.g., point cloud classification, point cloud model segmentation, point cloud flow analysis, and autonomous driving applications, this architecture is adapted to an AI-based Point Cloud Compression (PCC) framework. The overall process and the architecture details are according to some examples are described first and then how to apply the processes in a PCC framework.

The point feature extractor described below in accordance with some embodiments is applicable to all of the above example PCC frameworks. For the architectures of Yan and the '869 application, the present application's architecture and processes may enhance the representation of point features on both the encoder and decoder sides. For the example architectures of the '482 application and the '894 application, the present application's example architectures and processes in accordance with some embodiments may streamline the complexity of computing local geometric information.

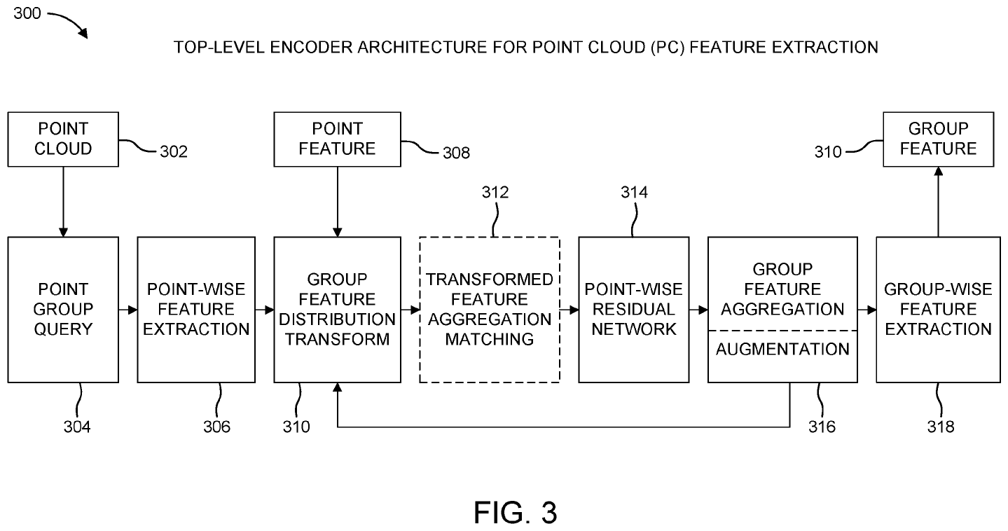

FIG. 3 is a functional block diagram illustrating an example encoder architecture for point cloud (PC) feature extraction according to some embodiments. A feature is a multi-dimensional vector representing an output of a neural network layer. In point cloud applications, these vectors are often extracted per-point (point-wise) through an MLP network. The overall example architecture 300 of the present application in accordance with some embodiments is illustrated in FIG. 3. One version of a feature extractor is a single point-wise block 306. A more advanced version queries for group points 304, extracts features of all points 306, aggregates by the group points, and runs a group-wise feature extraction 318 to generate a group feature 320. These two versions of an example architecture may perform cost-effective feature extraction, but there may be lack of accuracy and detailed feature representation.

A feature, such as a point-wise feature or a group-wise feature, may be represented as a high dimensional vector. A feature is a tensor of 3-dimensional points embedded in a higher dimensional space. For some embodiments, a machine learning process performing the embedding may be a necessary step. For some embodiments, a feature is a set of 3-dimensional points in a 3D point cloud model of an environment or scene. A feature may be generated by a machine learning process in some embodiments. The feature tensor may be used as the point cloud input 302 to the point group query 304 in FIG. 3 in some embodiments. For some embodiments, feedback may be expressed with a multi-stage architecture. A multi-stage architecture may be one of the many examples of learning-based point cloud compression (PCC) framework. For some embodiments, the features are the data passing through a learning-based PCC framework.

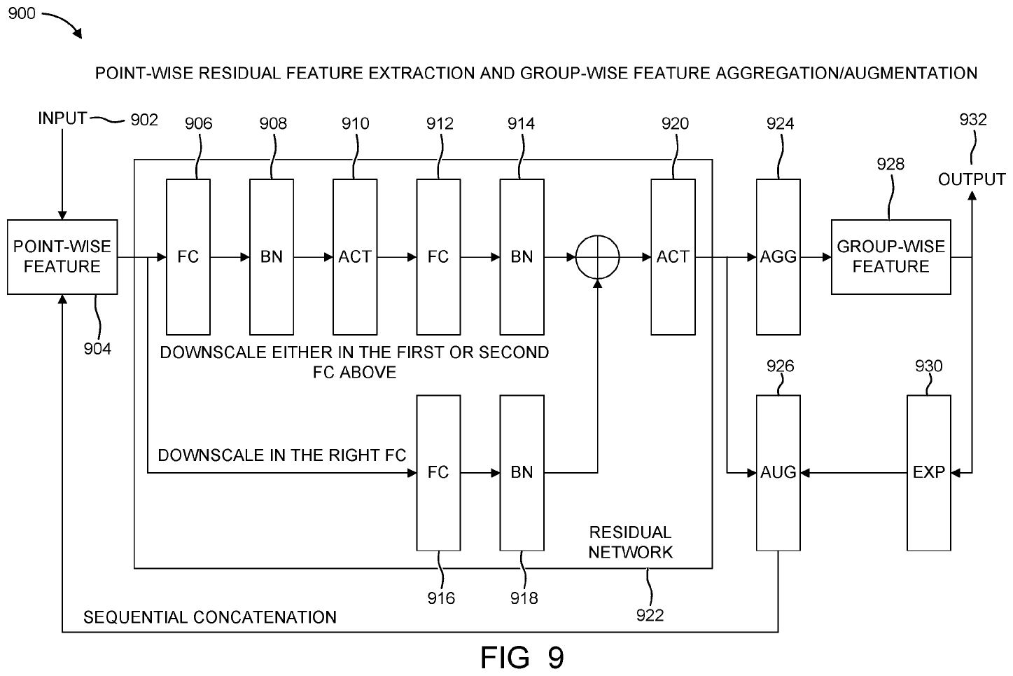

The present application focuses on more advanced feature aggregations for better (e.g., more accurate) representation of the PC features. In some embodiments, a deep distribution-aware point feature extractor 306 may be used. With some embodiments, a point feature 308 may be an input to a group feature distribution transform. For some embodiments, a transform is performed on a group feature distribution 310 and transformed features are aggregated and matched 312. In addition, deep residual-based local and global features may be combined 314, 316 to further enhance feature extraction. The sequence of these processes 310, 312, 314, 316 may be concatenated deeper to further improve the quality of the representing features. The dashed line in the aggregation/augmentation block 316 indicates branching for an additional output with the augmentation process. Augmentation is used if a new series continues via a feedback loop 316, 310. More detail on this branching is illustrated in FIG. 9.

For some embodiments, transformed feature aggregation matching, the dash-lined process 312, is another layer that may be added to mix the group features. For some embodiments, the group feature distribution transform process 310 may directly receive a point feature instead of embedded 3D points via the point-wise feature extraction 306. For some embodiments, the point group query (block (a)) may use an optimal number of group points for better (e.g., more accurate) reconstruction quality. For some embodiments, the feedback path of FIG. 3 may go from the output of the group feature aggregation and augmentation block (316 of FIG. 3) to the input of the point-wise residual network (314 in FIG. 3). This is possible because both blocks 310, 314 in FIG. 3 take the same feature dimension input.

A group query and analysis may classify the shape of a local neighborhood around a query position. Processing features with such a local neighborhood/group enables exploitation of the hierarchical structure of point clouds and often performs more accurate feature extraction of the PC.

For classification or segmentation of a PC, down-sampling may often be accompanied with group querying. This practice may be applied to a PCC framework, such as an end-to-end compression architecture, in which a PC quantization results in a down-sampling of points. For some embodiments, any grouping algorithms, such as the ball query or K-Nearest-Neighbors (KNN) algorithm, may be applied. Although, a ball query extracts more accurate geometric details, KNN may be an efficient, yet more straightforward process for a PCC framework.

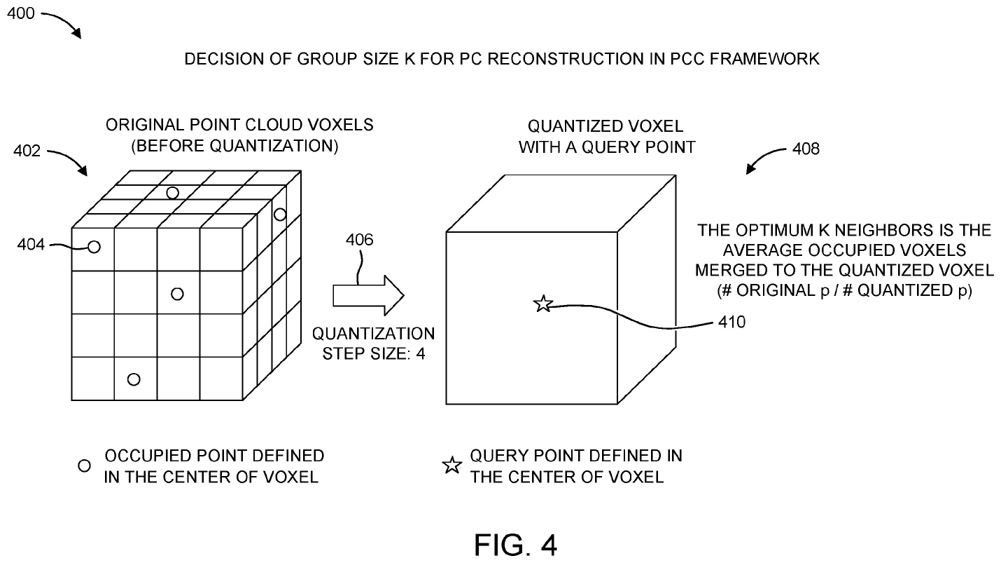

FIG. 4 is a functional block diagram illustrating an example of how a PC group size K may be decided for a given voxel quantization for PC reconstruction in a point cloud compression (PCC) framework according to some embodiments. As an example process 400 shown in FIG. 4, a group size K may be efficiently selected based on the quantization steps and the density of the occupied voxels 404 in the grid. The grid 402 on the left side of FIG. 4 is an original voxel representation of a 4-bit PC model. The left side 402 of FIG. 4 shows the original (occupied) point cloud voxels before quantization. The right side 408 of FIG. 4 shows the quantized voxel with a query point 410. Both occupied points 404 and query points 410 are considered to reside in the center of the respective voxels. By using a quantization 406 with, e.g., a step size of 4, the original 4×4×4 voxel grid is quantized to a 1×1×1 voxel, which is shown in the grid 408 on the right side of FIG. 4. All of the occupied points (circles) in the original grid 402 are represented by the single voxel point (star) in the quantized grid 408. For some embodiments, quantization or voxel quantization 406 may be used to perform grouping, and features may be extracted from the resulting groups.

The average number of original points per quantized grid point is the size of neighbors that are processed for a given quantization step. In other words, the quantity K_{avg} for an entire point cloud model is the average number of original points

$$( {N}_{avg}^{o} )$$

divided by the average number of quantized points

$$( {N}_{avg}^{q} ) :$$

$${K}_{avg} = {N}_{avg}^{o} / {N}_{avg}^{q} \qquad ( 1 )$$

in which

$${N}_{avg}^{o} = {\sum }_{i = 1}^{S} {N}_{i}^{o} / S and {N}_{avg}^{q} = {\sum }_{i = 1}^{S} {N}_{i}^{q} / S \cdot {N}_{i}^{o}$$

is the number of original points in the i-th point cloud model, and

$${N}_{i}^{q}$$

is the number of quantized points in the i-th point cloud model. The sums may be calculated across S point cloud models selected from a point cloud training dataset. For some embodiments, the point cloud training dataset may be, e.g., a million point cloud models, and only, e.g., several thousand point cloud models are used to calculate the averages. The obtained K_{avg} quantifies a tradeoff between computational cost and accuracy of the reconstruction. For some embodiments, the optimum K neighbors is the average number of occupied voxels merged into the quantized voxel (number of original points divided by number of quantized points).

In some embodiments, multiple training models with different K values may be trained in advance. The quantity K_{pc} of a specific point cloud may be formulated as shown in Eq. 2:

$${K}_{pc} = {N}_{pc}^{o} / {N}_{pc}^{q} \qquad ( 2 )$$

A trained network with the closest K compared to K_{pc} may be used for an inference. In this example context, an inference refers to reconstruction (which may include decoding) of a detailed point cloud from a quantized point cloud model. For some embodiments, the quantized point cloud is a simplified point cloud with less points than the original point cloud prior to quantization. For some embodiments, a quantized point cloud model may be generated using training data in a point cloud compression (PCC) framework. The inference may be made versus the training data.

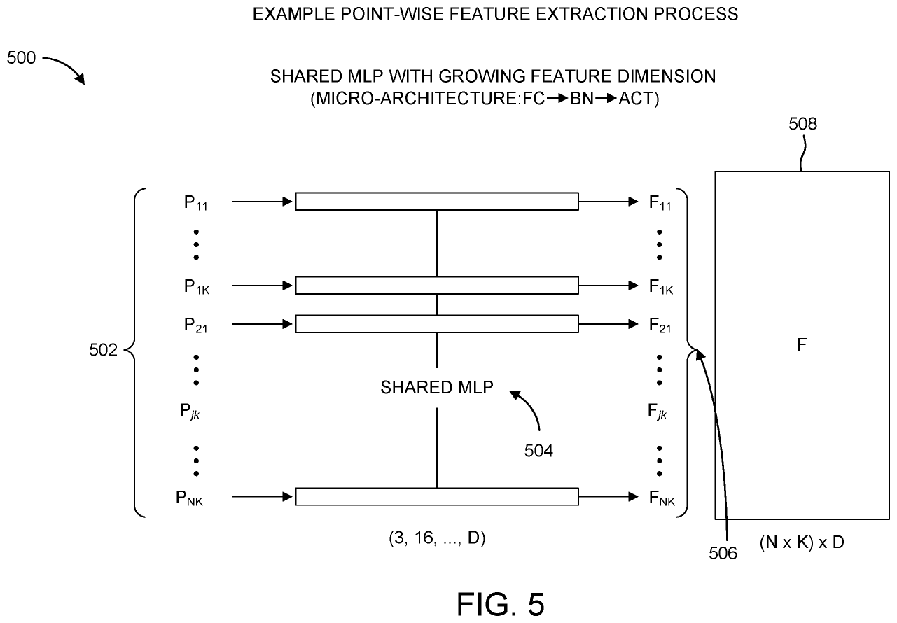

FIG. 5 is a functional block diagram illustrating an example point-wise feature extraction according to some embodiments. The methods and processes of the present application seek to extract meaningful PC features through a neural network. Along with the group points from each query point, 3-dimensional (N×K) positions 502 are embedded to a desirable feature dimension D. N is the number of query points, and K is the size of the group for output feature F 508. Such a process 500 may be used as a connector to the following methods and processes. As illustrated in FIG. 5, the feature dimension is progressively increased up to the desired size and then point-wisely connected to the next module. For some embodiments, a unit micro-architecture may combine a batch normalization (BN) layer in-between a fully connected (FC) layer and an activation function (ACT). The FC layer contains neurons which apply linear transformations to the input vector through a weights matrix. A non-linear transformation is then applied through an ACT. The BN layer, usually in between the FC and ACT, normalizes the weights to improve the performance of training. The fully connected layer, the batch normalization layer, and the activation layer may be used to configure a convolutional neural network (CNN) or multi-layer perceptron (MLP) 504 architecture. Looking at FIGS. 3 and 5, the group feature output may have (N×K) features 506 for some embodiments.

Exploiting the local groups of a point cloud may be used for point-based feature extraction. However, a hierarchical approach with set abstraction (SA) layers uses sampling functions such as farthest point sampling (FPS), which may not be differentiable depending on the purpose of use. Also, for each SA layer, both grouping and another pass of the PointNet network may be required, which is costly for a PCC framework. To avoid potential degradation factors for accuracy and cost-efficiency, a fully differentiable and distinctive method may be created that emphasizes the shape of local geometric information. In this sense, a grouping method may analyze group distributions of each feature dimension to better differentiate between local groups in an efficient manner.

For some embodiments, a distribution-aware feature in a PCC framework represents how a group of points surrounding a quantized point would be processed or interpreted. For some embodiments, a quantization may be done from an original and/or quantized voxel representation. Such a distribution-aware feature may be used to reconstruct a point cloud. For some embodiments, a point cloud compression (PCC) framework may be expressed as a learning-based point cloud geometry or artificial intelligence (AI)-based point cloud compression framework. For some embodiments, a geometry processing block may be a processing block within a learning-based PCC framework.

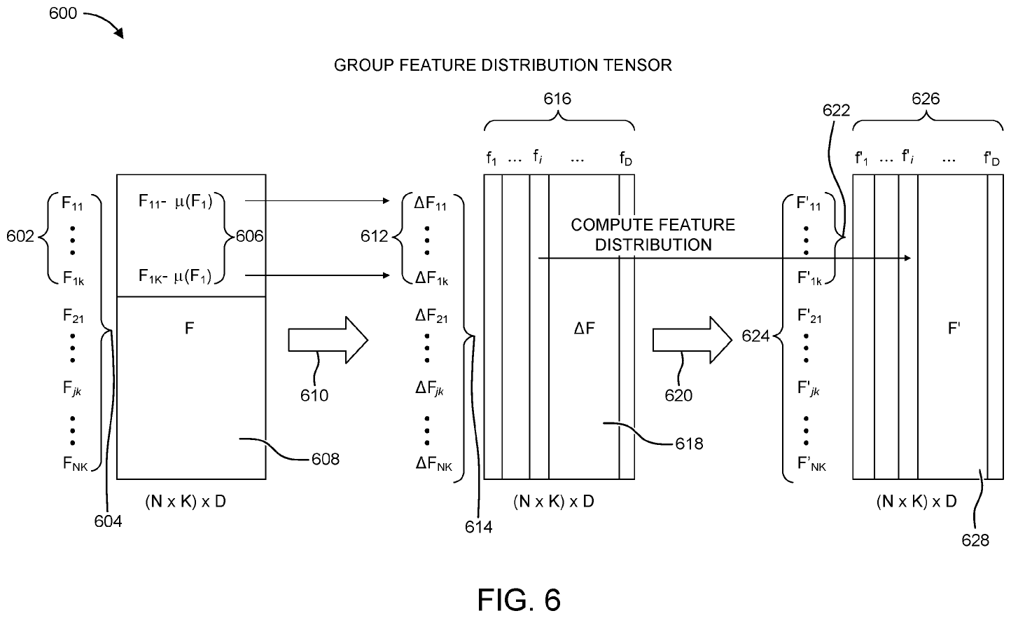

FIG. 6 is a functional block diagram illustrating an example group feature distribution tensor according to some embodiments. The detailed computation process 600 of the group distribution is computed as follows. As depicted in FIG. 6, the input point-wise feature tensor F 608 has N groups 604 of K points 602 per group multiplied by the feature size dimension, D. For some embodiments, item F₁₁ within item 602 of FIG. 6 is an example of a feature vector. For some embodiments, a feature vector may be row-wise or column-wise. The length of a feature vector is the norm value computed with the elements of the feature vector. This point feature F (F^{p}) may be a set of point-wise row features [F₁₁, F₁₂, . . . , Fⱼₖ, . . . , F_{NK}]^{T}. For each group j, a mean feature value is computed by Eq. 3:

$$μ ( {F}_{j} ) = \frac{( {\sum }_{k = 1}^{K} {F}_{jk} )}{K} \qquad ( 3 )$$

For each feature row Fⱼₖ, the corresponding mean feature value μ(Fⱼ) is subtracted to form a re-centered feature 606, 612, as shown in Eq. 4:

$$Δ {F}_{jk} = {F}_{jk} - μ ( {F}_{j} ) , j ∈ \{ 1 , … , N \} and k ∈ \{ 1 , … , K \} \qquad ( 4 )$$

All of these elements together 614 are expressed 610 as a modified tensor ΔF 618. For each column fᵢ 616 of the feature ΔF 618, the standard deviation, σ(fᵢ), is calculated for the whole column. Also, for each column fᵢ of the feature ΔF, the index i is a member of {1, . . . , D} in which D is the size of the feature dimension. Furthermore, a computation 620 may be performed on a group 622 formed together as a set of groups 624 to compute a feature distribution F′ 628, which may have a series of columns {1, . . . , D} 626.

For some embodiments, a feature map may be a set of channels, e.g., a quantity of C channels. The columns in items 616 and 626 of FIG. 6 are examples of feature maps with a quantity of D channels (e.g., in this example, here D=C). For some embodiments, examples of reshaped vectors are fᵢ and fᵢ′ in FIG. 6. For some embodiments, the length of a reshaped feature vector is the norm value computed with the elements of the reshaped feature vector. For some embodiments, the result of updating each of a series of vector elements by subtracting the respective mean is shown in ΔFⱼₖ of Eq. 4. In FIG. 6, the term “compute feature distribution” divides the elements by the respective standard deviation.

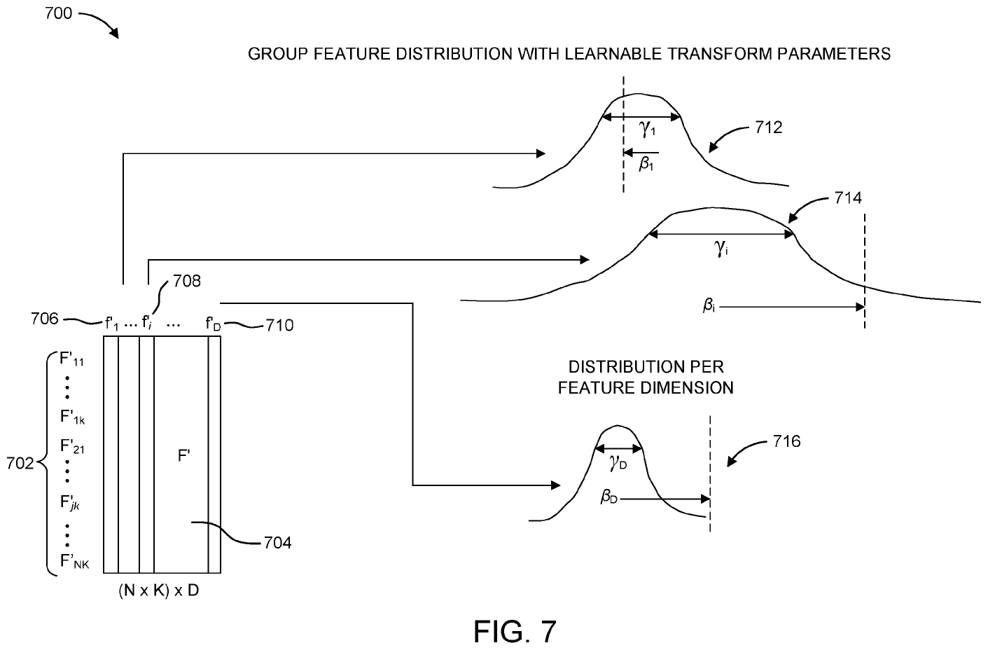

FIG. 7 is a functional block diagram illustrating an example group feature distribution with learnable transform parameters according to some embodiments. For some embodiments, γ (gamma) and β (beta) are learned from training. In some embodiments, distribution parameters may include transformation, or transform, parameters. In some embodiments, distributions parameters may be pre-determined, e.g., by neural network training. For some embodiments, distribution parameters, of which γ (gamma) and β (beta) are examples, may be determined using an example back-propagation technique during a training period. Such a training period may be for training a neural network. For some embodiments, a group distribution may be constructed by a process 700 on top of the feature tensor F′ 702, 704 (see FIG. 7), in which each column of this feature is split into a 1-dimensional vector f′ᵢ 706, 708, 710. Each column forms a bell curve centered around the group mean or a query point. These bell curves represent group distributions per feature dimension (D). The feature map F′ 704 in FIG. 7 is an example of a feature map with D channels. For some embodiments, these group distributions 712, 714, 716 are deformable individually via transform parameters γ and β such that the feature representation may further differentiate the shape of the corresponding feature dimension during point cloud (PC) reconstruction. For some embodiments, γ and β are examples of distribution parameters. For some embodiments, the term distribution parameters may be seen as a term that includes transform, or transformation, parameters. As illustrated in FIG. 7 and shown below in Eq. 5, f′ᵢ is the (final) distribution of the 1-dimensional feature fᵢ:

$${f}_{i}^{′} = {γ}_{i} [ {f}_{i} / ( σ ( {f}_{i} ) + ϵ ) ] + {β}_{i} \qquad ( 5 )$$

in which σ(fᵢ) is the standard deviation of column i for the 1-dimensional feature fᵢ of the feature ΔF. γᵢ is a transform parameter for column i, and transform parameter βᵢ is the offset of the bell curve for column i. In some embodiments, the standard deviation may be computed over the entire feature elements. Eq. 5 computes standard deviation over 1D elements. For some embodiments, a vector element of a feature map may be a point-wise vector. Normalizing such a vector element may be performed by dividing the vector element by the length of the vector element. For some embodiments, normalizing a reshaped vector element may be performed by dividing the reshaped vector element by the length of the reshaped vector element. Eqn. 5 shows a channel-wise vector. For some embodiments, Eq 5 divides the reshaped vector fᵢ by σ( )+ϵ. In some embodiments, the term σ( ) may be computed over the entire feature map elements instead of over the fᵢ elements. Also, Eqn. 5 may describe, on a per column basis, the relationship between the feature ΔF matrix and the output tensor F′ matrix of FIG. 6. For some embodiments, γᵢ is a learnable scalar coefficient. In some embodiments, γᵢ may be separated into multiple coefficients for a particular column i. For some embodiments, each of the N groups in a column may have separate transform parameters γᵢ and βᵢ, which may provide a better approximation of the original point cloud data. The (final) output tensor F′ is listed in Eq. 6:

$${F}^{′} = [ \begin{matrix}{f}_{1}^{′} & {f}_{2}^{′} & ⋯ & {f}_{i}^{′} & ⋯ & {f}_{D}^{′}\end{matrix} ] \qquad ( 6 )$$

For some embodiments, transform parameters γ and β may be split not only per feature dimension but also per group, which may further emphasize local distribution with a minor additional cost. In this case, the number of parameters increases from D to (K×D). D is the size of the feature dimension, and K is the size of the group for output feature F. For some embodiments, a density coefficient may be introduced to additionally weight the importance of each transform parameter in the tensor. For some embodiments, a slice may be divided into groups. The 1-dimensional feature elements are denoted as fᵢ. These elements fᵢ may be further split by the local group elements. If a point cloud is N local groups, the fi terms may be further split into N groups of elements. For some embodiments, a feature map may be a concatenation of per-slice feature elements, which may be computed by standardizing the corresponding slice from another feature map.

In a point-wise feature, each point is a member of a group. For each group member points, a mini-distribution may be computed with all group points centered around the group mean point. These processes are repeated for all the points in a point cloud scene. For some embodiments, this process may generate an updated point-wise feature that includes floating points in a matrix form. This process may be separated per feature dimension (which may be the matrix column or channel). For each set of point cloud data, the distribution of channel elements may vary in, e.g., range, amplitude, and average. In some embodiments, these distributions may be operated with transformation parameters which are learnable during a training process. These distribution curves may be transformed to enable a feature extractor better differentiate or emphasize each point feature.

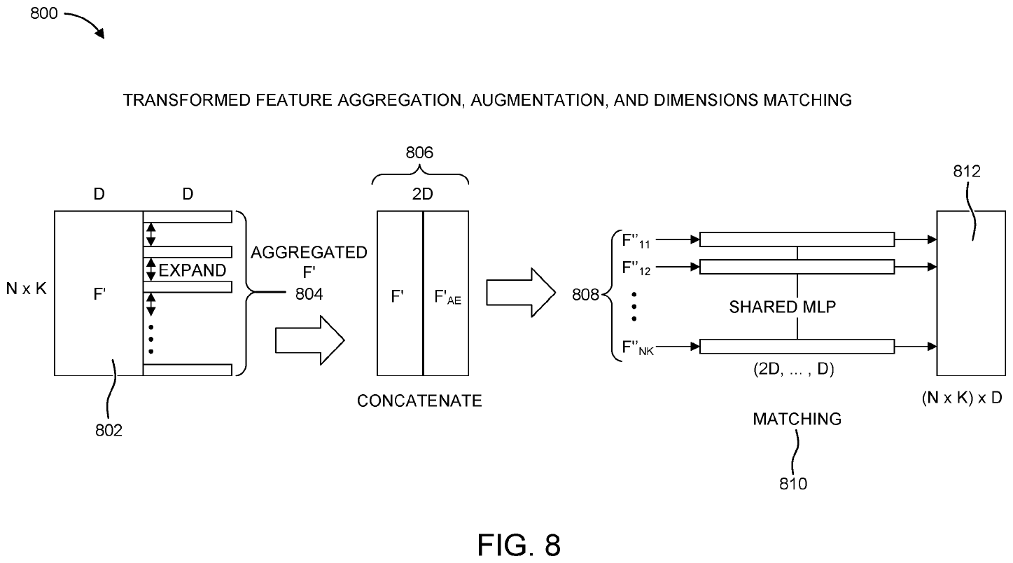

FIG. 8 is a functional block diagram illustrating an example transformed feature aggregation, augmentation, and dimension matching according to some embodiments. As shown in an example process 800 in FIG. 8, the global and local representations may be mixed and further enhancements may be made to the feature F′ 802. Local features may be aggregated and then the expanded tensor 804 may be augmented with the global feature. For some embodiments, dimension matching 810 may be performed, and the updated feature F″ 808 is output. The dimensions of F′ and F″ are identical. Therefore, the enhanced feature may be used with a group feature distribution transform and a point-wise residual network (310 and 314, respectively, of FIG. 3). For some embodiments, the term pooling refers to a function that aggregates multiple point features to one point feature, by averaging or taking the maximum values within the features. In FIG. 8, the aggregated feature F′ 804 is the result of the pooling operation. For some embodiments, a pooling operation may be a function of, for example, average pooling or max pooling. For some embodiments, a smoothing filter may be applied to a feature map. For example, the expanded feature F_{AE}′ in FIG. 8 is an example of an output of such a smoothing filter.

An efficient analysis of a local group may be acquired that is fully differentiable. As depicted in FIG. 8, the output feature F′ may be used independently for some embodiments or concatenated 806 with a group-wise aggregated and expanded feature (F_{AE}′) in some embodiments. A matching layer may follow that matches the feature dimension back to the input size. For some embodiments, the output 812 of the matching block 810 may reflect a conversion of the dimensions of the concatenation output, which is (N×K)×(2D), to the dimensions of the input, which is (N×K)×D.

A PointNet architecture is a cost-effective PC feature extractor. Because of its simplicity, a PointNet architecture may be used in a PCC framework. However, for some applications, a PointNet architecture lacks enough details, especially for a PCC framework, such as for a lower bitrate compression. To overcome this potential issue, a deeper network with a combination of global and local features all together through the network may be used in accordance with some embodiments. A residual network is, e.g., a specific network that learns residuals. A residual network may be used to design deeper neural networks. In some contexts, a deeper network may be used as a more general term compared to a residual network.

FIG. 9 is a functional block diagram illustrating an example point-wise residual feature extraction and group-wise feature aggregation and augmentation according to some embodiments. As shown in FIG. 9, an architecture 900 is present which may be used with a deeper network. To avoid degradation in a deeper network, a ResNet-like design is used. For some embodiments, a residual network block 922, such as the example shown in FIG. 9, may be based on a ResNet architecture. Article He, Kaiming, Deep Residual Learning for Image Recognition, ARXIV PREPRINT arXiv:1512.03385 (2015) (“He”) describes an example ResNet architecture. (See, for example, FIG. 3, right at p. 4.) In the example modified implementation shown in FIG. 9, in accordance with some embodiments, the image input of a ResNet architecture is replaced with a point cloud input 902. The convolution layer of a ResNet architecture is replaced with a fully connected (FC) layer. In order to match the feature dimension of the input and output, the input to the fully connected layer, which may be a point-wise feature 904, is downscaled. As such, the input to the FC layer 916 in the lower line is downscaled. In some embodiments, the input to the second FC layer 912 of the upper line (closer to the center of FIG. 9) is downscaled. For some embodiments, the downscaling is a downscaling by 2 for both the input to the FC layer in the upper line and in the lower line. Such a downscaling by 2 may be done to counteract the increase done in the AUG block 926. In some embodiments, the input to the first FC layer 906 of the upper line (closer to the left side of FIG. 9) is downscaled. Both global and local features are preserved by the “aggregation then augmentation” process. Unlike an image input, a 3D point cloud structure is irregular. Therefore, the convolution layer is replaced with a fully connected (FC) layer. The FC layer links the output of the preceding process block with the input of the following process block. For some embodiments, the FC layer outputs a linear transformation of the input. Each FC layer 906, 912, 916 is followed by a batch normalization (BN) 908. 914, 918 layer and an activation function (ACT) 910, 920. In some embodiments, the BN layer may be used to train the network and to help the network converge faster. The activation (ACT) function may be, e.g., a rectifier linear unit (ReLU) function in which negative values are replaced with a zero. For some embodiments, the BN layer may be omitted such that the output of the FC layer feeds into the ACT layer. To connect several of these processes sequentially and to be compatible with the previously-introduced distribution transformed tensor, the shape of the input may be matched with the output tensors. The feature dimension is downscaled (divided by 2) for the FC layer in both the residual path (top path in FIG. 9) and the shortcut path (bottom path in FIG. 9). Both outputs of the top and bottom paths are added together by the plus symbol (“⊕”), and then an activation function is applied. For some embodiments, each output of the top and bottom BN is a matrix (tensor) of floating point values. Because these matrices have the same dimension (size), the plus symbol (“⊕”) indicates a matrix addition of the elements. For some embodiments, the top path determines residual values that are added to a version of the input value from the bottom path. For some embodiments, if the dimensions of the point-wise feature input and the top path's BN layer output to the plus symbol (“⊕”) match, the bottom path may be a shortcut path without the FC layer and the BN layer. Such a scenario may occur, for some embodiments, if, e.g., the AUG function and the sequential concatenation feedback path are not performed.

So far, the point-wise features have been processed. Each group is aggregated (AGG) 924, and a group-wise feature 928 is created. For some embodiments, the group-wise feature is outputted 932. In some embodiments, the sequential blocks may be repeated with the output of the combined expansion (EXP) 930 and augmentation (AUG) 926 processes. During the augmentation, both the output feature of the residual network (prior to the AGG block) and the expanded group-wise feature (output of the EXP block) are concatenated. This concatenated feature is sent to the beginning to repeat the sequential blocks. For some embodiments, the aggregation (AGG) block of FIG. 9 is similar to the aggregation process of FIG. 8. In some embodiments, the expansion (EXP) block of FIG. 9 is similar to the expansion process of FIG. 8. With some embodiments, the augmentation (AUG) block of FIG. 9 is similar to the concatenation process of FIG. 8.

For some embodiments, the architecture shown in FIG. 9 may be inserted into the architecture of FIG. 3 in which the residual network block of FIG. 9 is used for the point-wise network (block (e) of FIG. 3). The AGG, AUG, and EXP blocks of FIG. 9 are used for the group feature aggregation and augmentation block (block (f) of FIG. 3). For some embodiments, the feedback path of FIG. 3 may go from the output of the group feature aggregation and augmentation block (block (f) of FIG. 3) to the input of the point-wise residual network (block (e) in FIG. 3). Such a configuration for the feedback path in FIG. 3 may be used if the architecture shown in FIG. 9 is inserted into the architecture of FIG. 3, in which the sequential concatenation feedback path of FIG. 9 is the feedback path in FIG. 3.

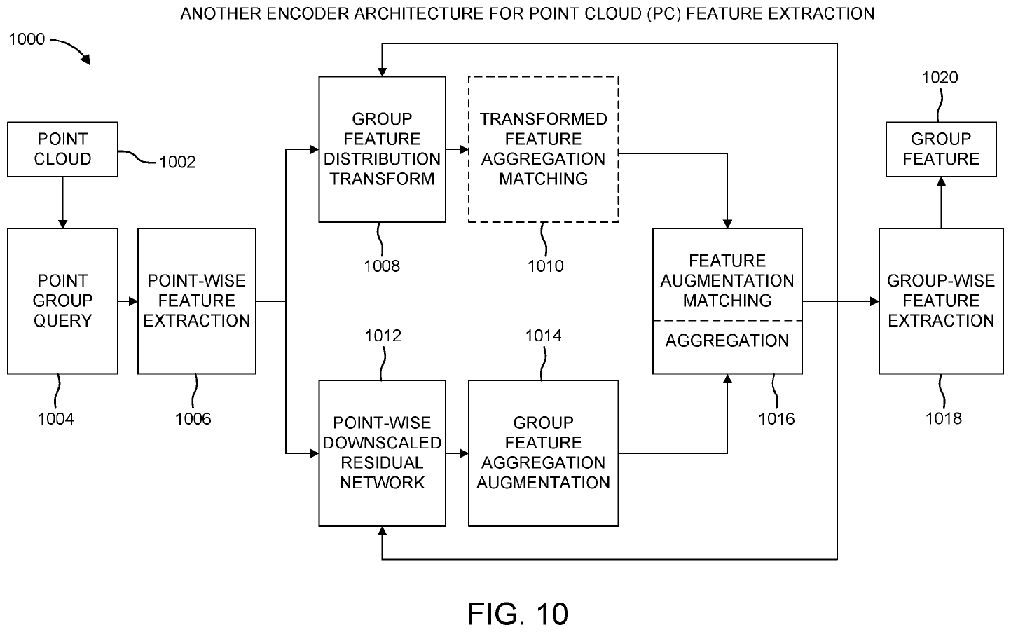

In some embodiments, this deep residual process may work jointly and advantageously with a distribution-aware process. In some embodiments, the distribution-aware process may be blocks 310 and 312 of FIG. 3. In some embodiments, the distribution-aware process may be block 310 of FIG. 3. In some embodiments, the deep residual process may be blocks 314 and 316 of FIG. 3. In each stage, features of both processes may be connected either in series (see FIG. 3) or in parallel (see FIG. 10). The rich representation is propagated through a deep network. In other words, a deep feature extracting process may be sequentially connected without degradation while preserving local geometric information. Moreover, maintaining compatibility of the in/out dimensions facilitate to create variant designs for different purposes.

FIG. 10 is a functional block diagram illustrating an example encoder architecture for PC feature extraction according to some embodiments. The overall architecture assembles several processes in series, however, as shown in FIG. 10, some embodiments may use a parallel architecture 1000. For some embodiments, a point cloud 1002 is an input to a point group query 1004, which outputs to a point-wise feature extraction 1006.

In comparison with FIG. 3, one difference is that the distribution transform 1008, 1010 in FIG. 10 uses independent parallel paths (path 1 of 1008, 1010 and path 2 of 1012, 1014) and then augments 1016 these outputs with the features coming from residual modules. The dimension of the output 1016 is later matched with a micro-architecture (matching) similar to the one introduced with FIG. 8 to generate a group feature 1020. To finalize the deep stage, a final aggregation (under the dashed line of block 1016) is performed and then group-wise feature extraction 1018 is performed. For some embodiments, the group size K may be 1, in which case the group feature may be called a point feature.

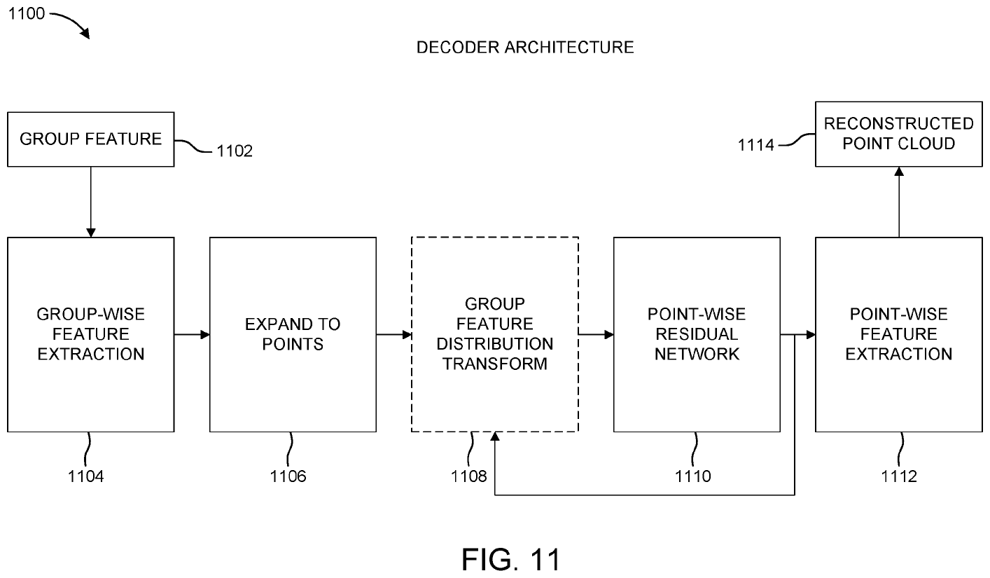

FIG. 11 is a functional block diagram illustrating an example decoder architecture according to some embodiments. For an end-to-end PCC framework, a decoder is used with an encoder. For some embodiments, as depicted in FIG. 11, another architecture 1100 for a decoder is applicable. In some embodiments, a first point-wise extractor may increase the feature dimension. Several of the processes described above may occur between a first point-wise extractor and a second point-wise extractor. The second point-wise extractor may decrease the feature dimension to 3D to reconstruct the final decompressed point cloud. For some embodiments, there is no aggregation/grouping in the decoder, and the dimensions of the decoder input data 1102 is N groups by the feature dimension D (N×D).

In some embodiments, a decoder architecture may obtain group feature data. The decoder process may extract 1104 group-wise features from the group feature data. Then, the size of the group may be matched/expanded 1106 to the size of the points. The expanded point-wise features may be sent to a group feature distribution transform process 1108, which may perform a transform on the group feature distribution. The transformed features may be inputted into a point-wise residual network 1110, which may generate residual-based feature data. The decoder process may run a point-wise feature extraction 1112 to extract a reconstructed point cloud 1114.

PC feature extraction in AI-based PCC architecture is a relatively new area compared to PC classifications or segmentations. In Yan and the '869 application, the PC feature extractor, e.g., defines MLP layers followed by an aggregation step. Although PCC frameworks seek a cost-effective architecture, there is still room to better represent PC features. For some embodiments, the feature extractor described above may be used in a PCC framework and performance of the compressions may be improved. The enhanced feature extractor may be used for other tasks, such as segmentation and point cloud classification.

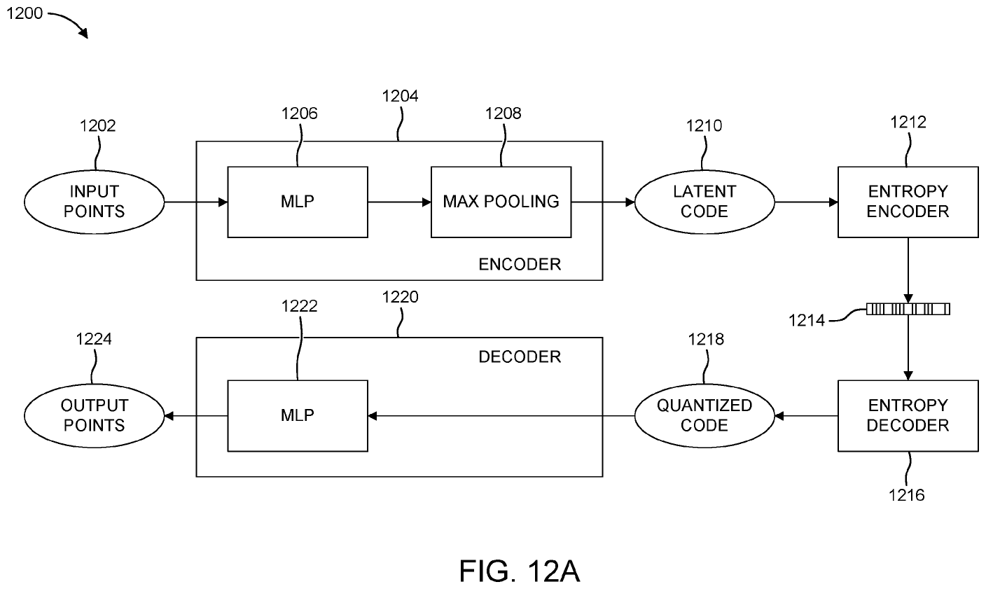

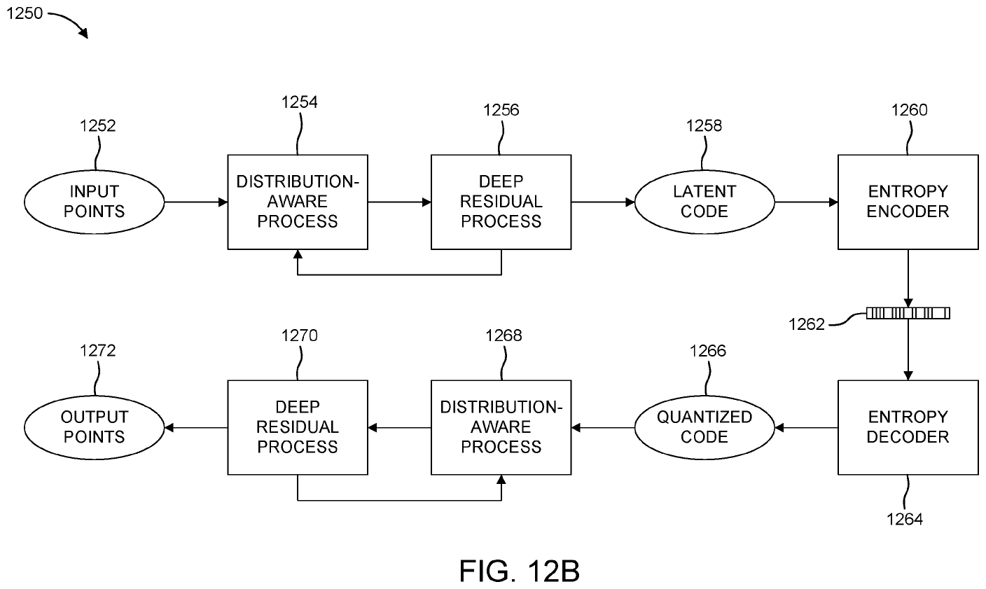

FIG. 12A is a functional block diagram illustrating an example application of a PCC framework to an encoder and a decoder in an autoencoder-based lossy geometry compression. As shown in FIG. 12A, Yan uses an end-to-end PCC architecture 1200. The encoder 1204 and decoder 1220 are designed with MLPs 1206, 1222 and a pooling layer 1208.

Yan discusses four modules: a PointNet-based encoder, a uniform quantizer, an entropy estimation block, and nonlinear synthesis transformation module. Yan uses an auto-encoder as the compression platform. As mentioned on page 4323, first column of Yan:
Firstly, the input point cloud is downsampled by the sampling layer S to create a point cloud with different point density. Then, the downsampled point set goes through the autoencoder-based codec. The codec consists of an encoder E that takes an unordered point set as input and produces a compressive representation, a quantizer Q, and a decoder D that takes the quantized representation produced by Q and produces a reconstructed point cloud.

As shown in FIG. 12A, a downsampled point cloud is used as the input points 1202. These points serve as the multi-layer set of points that undergo (max) pooling as part of the encoding process. The encoder output, which is a latent code 1210, is sent through an entropy encoder 1212 to generate the comprehensive representation, which is the bitstream 1214 shown on the right side of FIG. 12A between the entropy encoder 1212 and the entropy decoder 1216. The comprehensive representation is passed through an entropy decoder 1216 to generate a quantized code 1218. The quantized code 1218 is passed through the decoder to reconstruct a multi-layer set of points that are the outputted point cloud 1224.

FIG. 12B is a functional block diagram illustrating an example application of a PCC framework to an encoder and a decoder in an autoencoder-based lossy geometry compression according to some embodiments. For some embodiments of an encoder/decoder architecture 1250, the encoder and the decoder on the left side of FIG. 12A may be replaced, as shown in FIG. 12B, by the architectures of FIG. 3 or FIG. 10. For example, in some embodiments, the encoder of FIG. 12A may be replaced by a distribution-aware process 1254, a deep residual process 1256, and a feedback path as shown in FIG. 12B. Similarly, for some embodiments, the decoder of FIG. 12A may be replaced by a distribution-aware process 1268, a deep residual process 1270, and a feedback path as shown in FIG. 12B. As a result, a higher quality latent code 1258 and a higher quality quantized code 1266 may be generated. Such codes may contain more representative PC features with a small increase in computational cost. For some embodiments, the encoder of FIG. 12A is replaced with the encoder architecture of FIG. 10. For the input points 1252 of FIG. 12B, the input points of FIG. 12A are replaced with the point cloud input into the Point Group Query (block 1004 of FIG. 10). The group feature output of the group-wise feature extraction (block 1018 of FIG. 10) is the latent code of FIG. 12A. For some embodiments, the latent code 1258 is an input into an entropy encoder 1260, which outputs a bitstream 1262. For some embodiments, the bitstream 1262 is an input into an entropy decoder 1264, which outputs a quantized code 1266. For some embodiments, the decoder of FIG. 12A is replaced with the decoder architecture of FIG. 11, in which the quantized code of FIG. 12A is the group feature input into the Group-Wise Feature Extraction (block 1104 of FIG. 11), For the output points 1272 of FIG. 12B, the reconstructed point cloud output of the point-wise feature extraction (block 1112 of FIG. 11) replaces the output points of FIG. 12A.

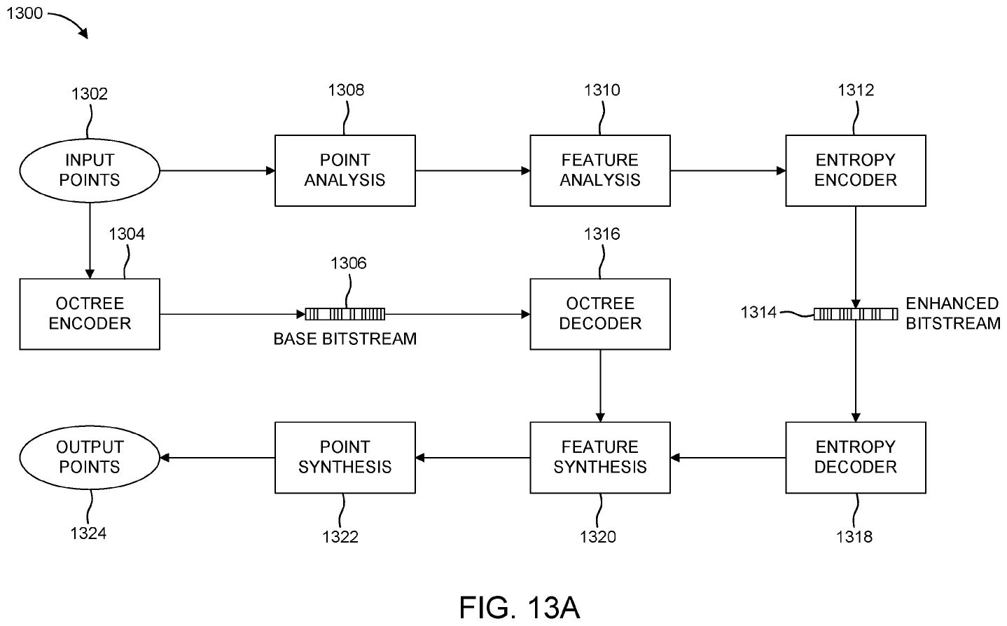

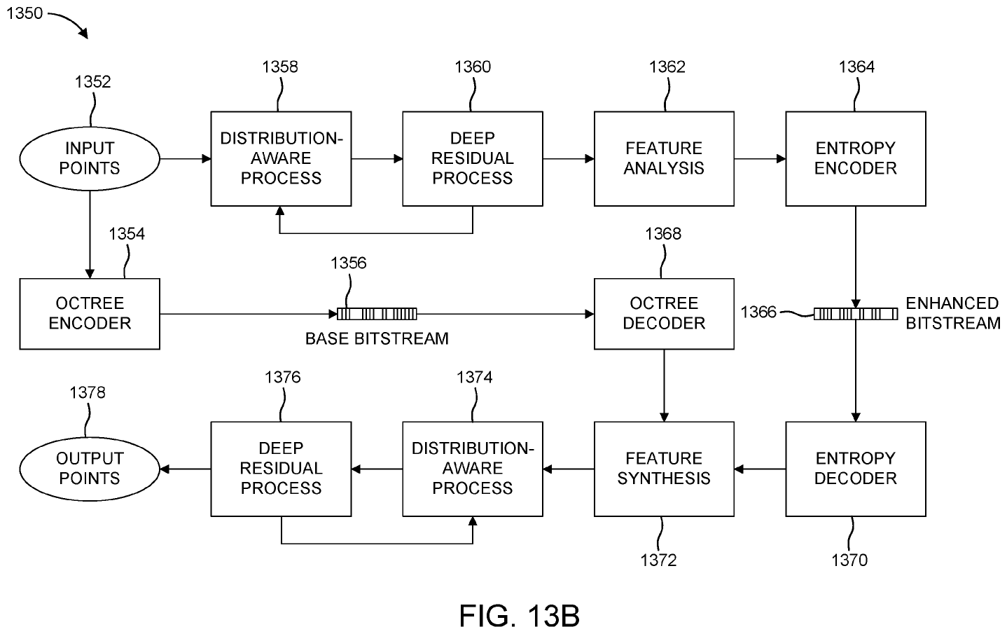

Another example from the '869 application is illustrated in FIG. 13A. FIG. 13A is a functional block diagram illustrating an example application of a PCC framework to a point analysis and point synthesis within a scalable PCC framework. The '869 application introduces a scalable end-to-end PCC framework. This application focuses on feature analysis and synthesis rather than point analysis and synthesis. Again, in this framework, the MLP and aggregation layer are combined in both the “res-to-feature converter (point analysis in the encoder)” block and the “feature-to-res converter (in the decoder)” block. For some embodiments, a geometry processing block within a leaning-based PCC framework may be, for example, one or more of the blocks in FIG. 13A, such as blocks 1304, 1308, 1310, 1312, 1316, 1318, 1320, and/or 1322.

The '869 application discusses a lossy point cloud compression scheme to encode point cloud geometry with deep neural networks. For such a scheme 1300, a coarse version of an input point cloud 1302 is encoded 1304 as a first bitstream 1306 (BS₀ of FIG. 5 of the '869 application), and the residual data (fine geometry details) is encoded 1312 as point-wise features of a second bitstream 1314 (BS₁ of FIG. 5 of the '869 application). The residual data may be generated by point analysis 1308 and feature analysis 1310.

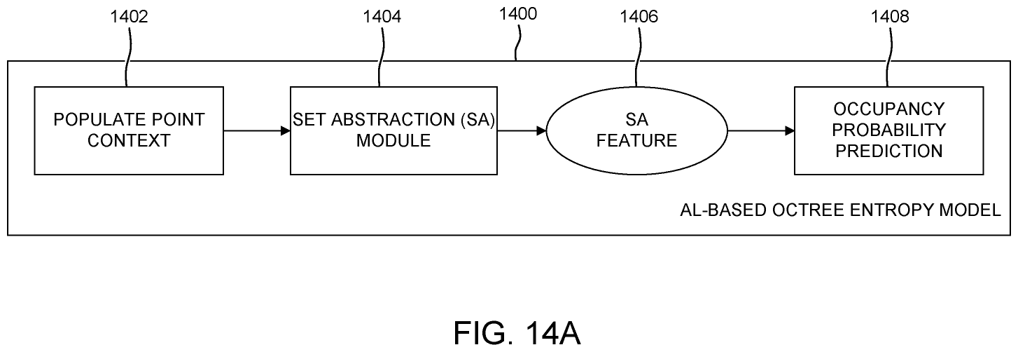

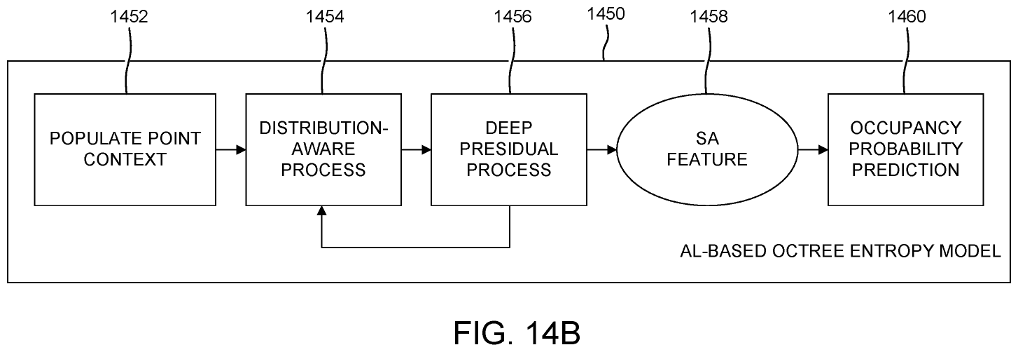

On the decode side, the coarse point cloud (PC₁ of FIG. 14 of the '869 application) is decoded 1316 from the first bitstream (BS₀ of FIG. 14 of the '869 application). The residual data (R′ of FIG. 14 of the '869 application) is decoded 1318 from the point-wise features (F′ of FIG. 14 of the '869 application) and added 1320, 1322 to the coarse point cloud to retrieve the decoded version 1324 (PC₀ of FIG. 14 of the '869 application) of the original input point cloud.

FIG. 13B is a functional block diagram illustrating an example application of a PCC framework to a point analysis and point synthesis within a scalable PCC framework according to some embodiments. For some embodiments, input points 1352 may be inputted into an octree encoder 1354 and a distribution-aware process 1358. The octree encoder 1354 outputs a base bitstream 1356, which is inputted into an octree decoder 1368. For an end-to-end PCC compression 1350, selection of a group size K may influence the level of enhancement and performance of the compression. Moreover, a high-quality representation of PC features may improve the performance of the reconstruction, especially for lower bitrate cases. For example, the point analysis process of FIG. 13A may be replaced by the architecture proposed in FIG. 3 or FIG. 10, with an additional flexibility to add or remove processes, such as block 312 in FIG. 3 and block 1010 in FIG. 10. For some embodiments, the point synthesis process of FIG. 13A may be replaced by the architecture proposed in FIG. 11. For example, in some embodiments, the point analysis process of FIG. 13A may be replaced by a distribution-aware process 1358, a deep residual process 1360, and a feedback path as shown in FIG. 13B. Similarly, for some embodiments, the point synthesis process of FIG. 13A may be replaced by a distribution-aware process 1374, a deep residual process 1376, and a feedback path as shown in FIG. 13B. For some embodiments, the point analysis of FIG. 13A is replaced with the encoder architecture of FIG. 10, in which the input points of FIG. 13A is the point cloud input into the Point Group Query (block 1004 of FIG. 10) and the group feature output of the group-wise feature extraction (block 1018 of FIG. 10) is the input to the feature analysis of FIG. 13A. For some embodiments, the point synthesis of FIG. 13A is replaced with the decoder architecture of FIG. 11, in which the feature synthesis output of FIG. 13A is the group feature input into the Group-Wise Feature Extraction (block 1104 of FIG. 11) and the reconstructed point cloud output of the point-wise feature extraction (block 1112 of FIG. 11) is the output points of FIG. 13A.

For some embodiments, the deep residual process 1360 outputs to a feature analysis process 1362, which in turns outputs to an entropy encoder 1364. The output of the entropy encoder is an enhanced bitstream 1366, which in turn is an input to an entropy decoder 1370. The entropy decoder 1370 outputs to the feature synthesis 1372. For some embodiments, the feature synthesis 1372 takes inputs from the octree decoder 1368 and the entropy decoder 137 and outputs to the distribution-aware process 1374. The output of the deep-residual process 1376 is the set of output points 1378.

FIG. 14A is a functional block diagram illustrating an example application of a PCC framework to a set abstraction (SA) process in a PointContextNet environment. FIG. 14A depicts an example method 1400 from the '482 application that uses AI-based octree-structured entropy models.

The 482 application discusses retrieving a point cloud that is compressed based on a tree structure and retrieving points in the neighborhood of a node of the tree structure. Two features 1406 are calculated 1404 from the retrieved data and their locations 1402. The '482 application fuses the two features with one or more known features of the node and eventually determines occupancy 1408 for the current node from the encoded bitstream and a predicted occupancy symbol distribution.

FIG. 14B is a functional block diagram illustrating an example application of a PCC framework to a set abstraction (SA) process in a PointContextNet environment according to some embodiments. The architecture in FIG. 3 or FIG. 10 may replace the SA process/module of FIG. 14A. For example, in some embodiments, the SA process 1404 of FIG. 14A may be replaced by a distribution-aware process 1454, a deep residual process 1456, and a feedback path as shown in FIG. 14B. For some embodiments, the set abstraction (SA) process 1404 of FIG. 14A is replaced with the encoder architecture of FIG. 10, in which the output of the populate point context block 1402 of FIG. 14A is the point cloud input into the Point Group Query (1004 of FIG. 10) and the group feature output of the group-wise feature extraction (1018 of FIG. 10) is the SA feature 1406 of FIG. 14A.

For some embodiments, an example process 1450 may populate point context 1452 into a distribution-aware process 1454. The output of the deep-residual process 1456 may be an SA feature 1458, which in turn may be an input to an occupancy probability prediction 1460.

The architecture extracts cost-effective features with high-level representations via a feature distribution transform and a deep residual architecture within the octree entropy model of the PCC framework. Other than the SA layers, several processes described above, such as the processes 310, 312, 314, 316, 318 of FIG. 3, may be used in place of the FC layers in both PointContextNet and CRM architectures.

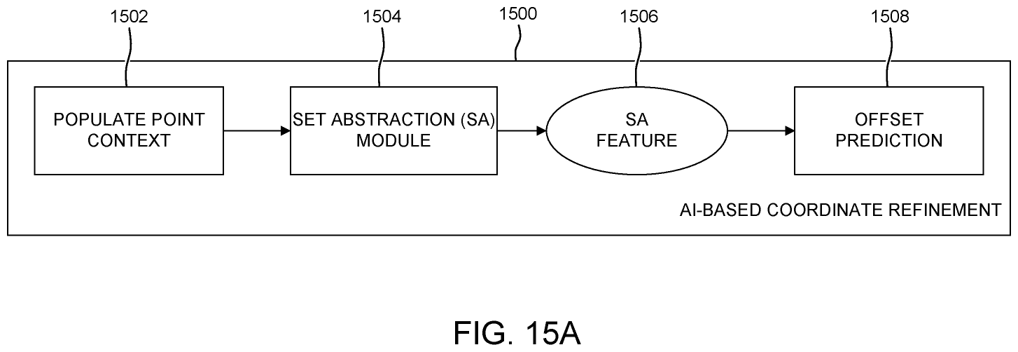

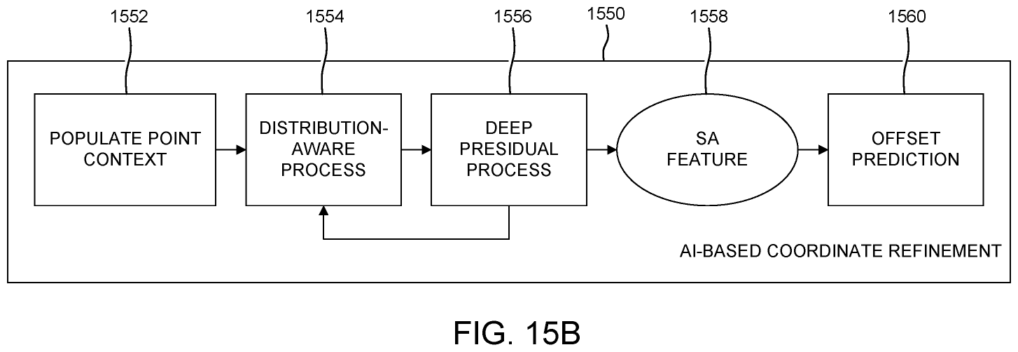

FIG. 15A is a functional block diagram illustrating an example application of a PCC framework to a set abstraction (SA) process in a coordinate refinement module (CRM). The '894 application discusses coordinate refinement and up-sampling of quantized and reconstructed point cloud data. Neighboring points of a decoded point cloud may be determined by an AI-based coordinate refinement process 1500. Based on a property of one of those neighboring points, a refinement feature may be determined using a neural network technique. The refinement feature may be used to predict 1508 a refinement of the decoded point cloud.

FIG. 15B is a functional block diagram illustrating an example application of a PCC framework to a set abstraction (SA) process in a coordinate refinement module (CRM) according to some embodiments. The architecture in FIG. 3 or FIG. 10 may replace the SA process/module of FIG. 15A. For example, in some embodiments, the SA process 1506 of FIG. 15A may be replaced by a distribution-aware process 1554, a deep residual process 1556, and a feedback path as shown in FIG. 15B. For some embodiments, the set abstraction (SA) process 1504 of FIG. 15A is replaced with the encoder architecture of FIG. 10, in which the output of the populate point context block 1502 of FIG. 15A is the point cloud input into the Point Group Query (1004 of FIG. 10) and the group feature output of the group-wise feature extraction (1018 of FIG. 10) is the SA feature of FIG. 15A.

For some embodiments of a process 1550, the populate point context 1552 is an input into a distribution-aware process 1554. In some embodiments, the output of the deep residual process 1556 is an SA feature 1558, which in turn may be an input into an offset prediction 1560.

Compared to the methods of Yan and the '869 application, the methods of the '482 application and the '894 application apply a more advanced feature extractor with set abstraction (SA) modules and further enhancement with multi-resolution (MRG) or multi-scaled (MSG) groupings. Along with SA layers, a series of FC layers are followed. While these architectures may extract good, representative PC features with a hierarchical and multi-level approach, there may be a high computational cost which may be less favorable for some implementations.

In this application, a deep distribution-aware point feature extractor for point cloud data is described. This architecture may be used in an AI-based point cloud compression (PCC) framework, as well as other architectures. A PCC framework uses a well-balanced trade-off between the accuracy of reconstruction and the computational cost. A per-channel feature distribution transform process may be used in furtherance of such a goal. A deep residual-based network with repeated mixture of global and local information may be used for further enhancement. Two of the processes described earlier may be used in both the encoder and decoder of a given PCC framework.

For some embodiments, the input and output of the feature extractor described in the present application may be a point-wise feature. As such, the feature extractor described herein may be plugged into the frameworks shown in FIGS. 12A, 13A, 14A, 15A as illustrated, e.g., in FIGS. 12B, 13B, 14B, and 15B, respectively.

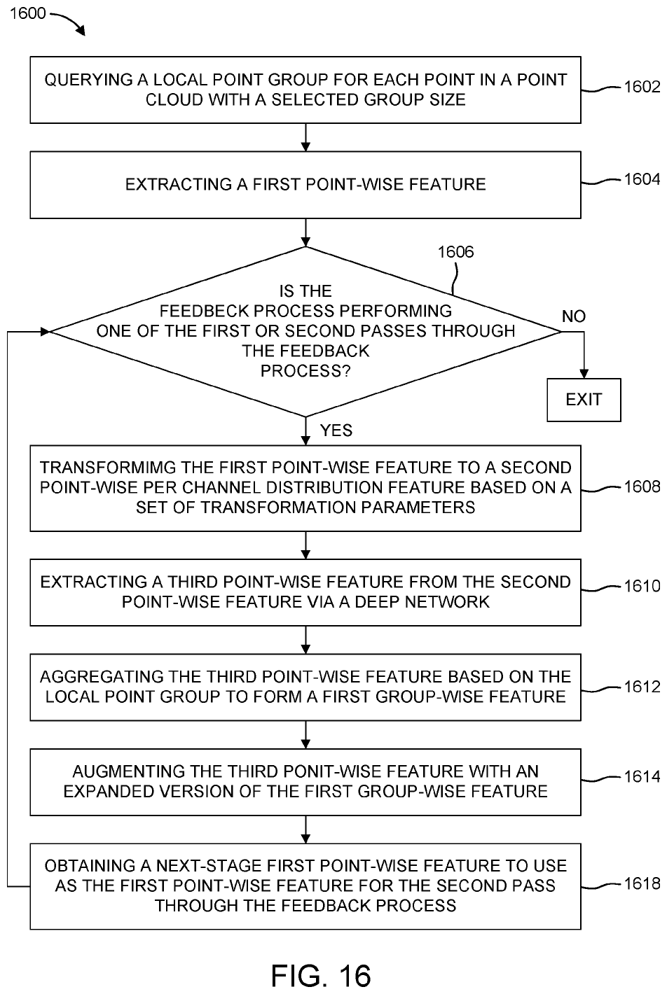

FIG. 16 is a flowchart illustrating an example process for point cloud feature extraction according to some embodiments. For some embodiments, an example process 1600 may include querying 1602 a local point group for each point in a point cloud with a selected group size. For some embodiments, the example process may further include extracting 1604 a first point-wise feature. For some embodiments, the example process may further include performing 1606 a first and second pass through a feedback process. For some embodiments, the example feedback process of the example process may include transforming 1608 the first point-wise feature to a second point-wise per-channel distribution feature based on a set of transformation parameters. For some embodiments, the example feedback process of the example process may further include extracting 1610 a third point-wise feature from the second point-wise feature via a deep network. For some embodiments, the example feedback process of the example process may further include aggregating 1612 the third point-wise feature based on the local point group to form a first group-wise feature. For some embodiments, the example feedback process of the example process may further include augmenting 1614 the third point-wise feature with an expanded version of the first group-wise feature. For some embodiments, the example feedback process of the example process may further include obtaining 1616 a next-stage first point-wise feature to use as the first point-wise feature for the second pass through the feedback process.

### Deep Feature Coding for PCC

Learning-based PCC approaches can be divided into two major groups: deep octree-based PCC and deep feature-based PCC. In octree-based PCC, the occupancy of voxels is directly entropy coded into bitstreams. Learning-based methods are used to predict the probability of these voxel occupancies. In deep feature-based PCC, the geometric features are quantized and compressed in an end-to-end manner.

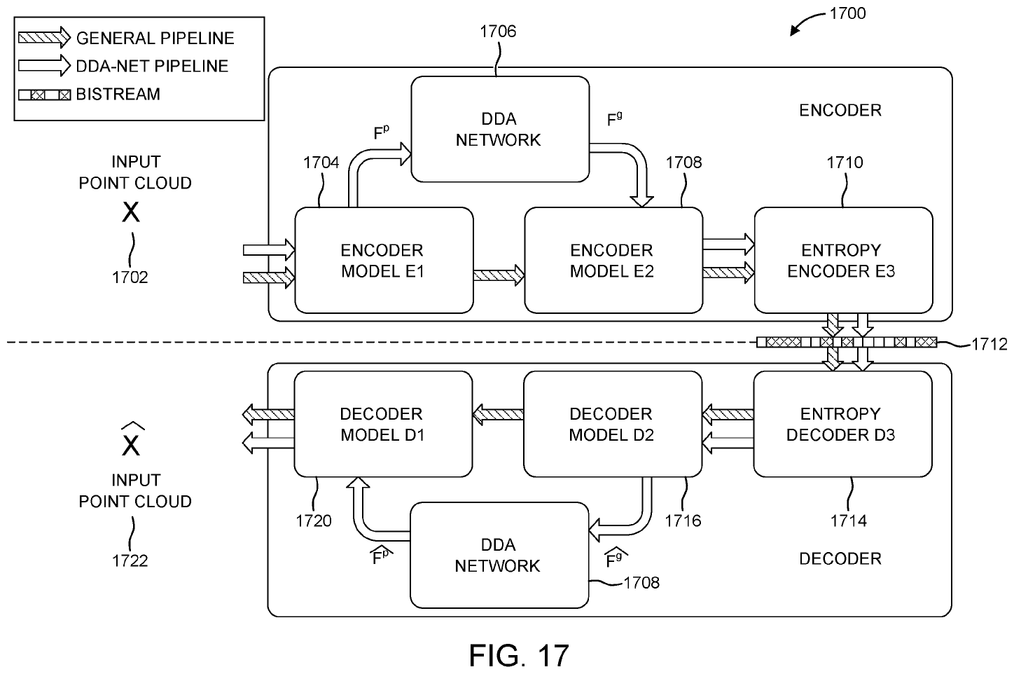

FIG. 17 is a functional block diagram illustrating a deep-feature-based PCC pipeline according to some embodiments. The dashed gray arrows in FIG. 17 show the data flow of a general deep-feature-based PCC framework 1700. The encoder E1 1704 extracts intermediate features from the input point cloud X 1702. The encoder E2 1708 further squeezes the intermediate features to optimize the compression with the entropy encoder E3 1710. On the decoder, the entropy decoder D3 1714 decodes the coded features from the bitstream 1712. The decoder D2 1716 processes the intermediate features, and the decoder D1 1720 reconstructs the final decoded point cloud x 1722.

To extract distinctive features for PCC, a deep distribution-aware network (DDA-Net) may be used in combination with a general deep-feature-based PCC pipeline, as shown in FIG. 17. A DDA-Net block 1706, 1718 is inserted between the E1 and E2 encoders for the encoder side of the bitstream and between the D1 and D2 decoders for the decoder side of the bitstream. The DDA-Net block takes as inputs the intermediate features generated by the E1 encoder (or the D2 decoder) and manipulates the distributions to further discriminate them for the point cloud compression (PCC). The modified features are inputted to the E2 encoder (or D1 decoder).

The DDA-Net block may be applied to GRASP-Net, a PCC framework that combines both point-based and voxel-based architectures. GRASP-Net is described in Pang, J., et al., GRASP-Net: Geometric Residual Analysis and Synthesis for Point Cloud Compression, PROC. OF THE 1ST INTERNATIONAL WORKSHOP ON ADVANCES IN POINT CLOUD COMPRESSION, PROCESSING, AND ANALYSIS 11-19 (2022) (“Pang”). Particularly, the E1 and E2 encoders correspond to a PointNet (point analysis in Pang) and a CNN-based down-sampling (feature analysis in Pang), respectively. On the decoder, D1 and D2 correspond to MLP layers (point synthesis in Pang) and CNN-based up-sampling (feature synthesis in Pang). The in/out pairs F^{p}/\hat{F}^{p} and \hat{F}^{g}/F^{g} share the same dimensions. The DDA-Net manipulates feature distributions closer to the in/out point clouds rather than the E3 encoder and D3 decoder.

### Distribution-Aware Feature Manipulation

Given a set of point-wise feature Fₗ∈ [symbol] ^{D}, with l being the point index and D being the feature dimension, the distributions of the feature elements in Fₗ are modeled as i.i.d. Gaussians. Thus, the joint distribution of the vector Fₗ may be parameterized by a multivariate Gaussian with mean μ and standard deviation σ both in [symbol] ^{D}. A network f_{d}: [symbol] ^{D}→ [symbol] ^{D} that manipulates the distribution of each feature element in Fₗ is sought to facilitate a more descriptive feature.

A standardization process

$${F}_{l}^{′} = \frac{( {F}_{l} - μ )}{σ}$$

is performed to normalize the feature values. The mean feature is μ. The standard deviation is σ. The division is an element-wise division. This Gaussian model is varied by transforming (scaling and shifting) to a deformed curve.

### DDA-Net Architecture

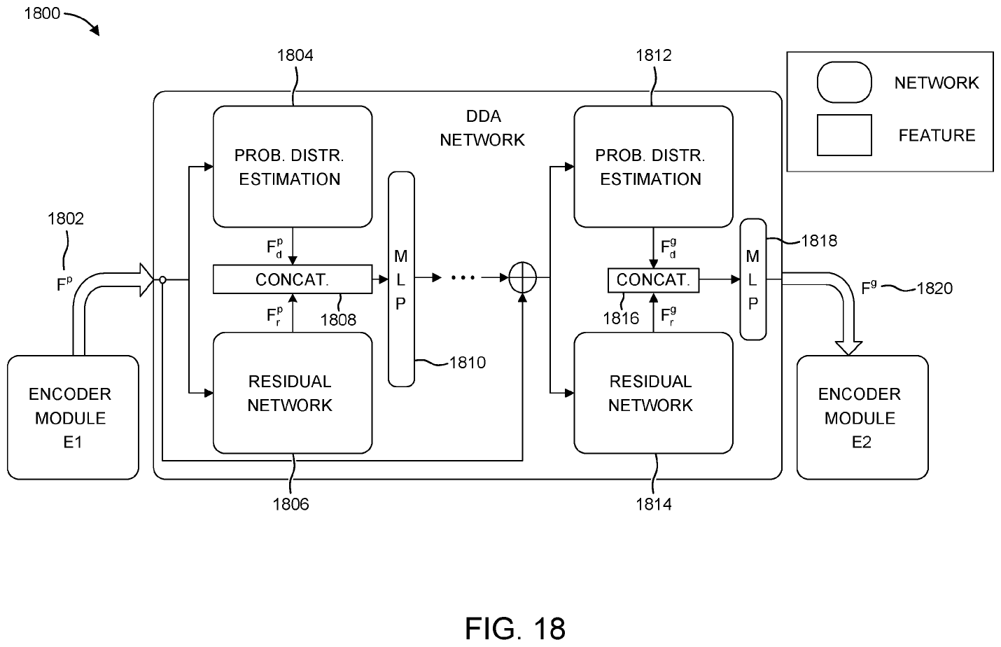

FIG. 18 is a functional block diagram illustrating a DDA-Net encoder architecture according to some embodiments. A deep distribution-aware network (DDA-Net) is shown in FIG. 18, with the feature map F^{p} 1802 of Eq. 7 as its input:

$${F}^{p} = \{ {F}_{jk}^{p} \} ∈ {ℝ}^{NK \times D} \qquad ( 7 )$$

where NK is the size of the feature map.

The initial feature map F^{p} is inputted into a probability distribution estimation function 1804, 1812 that outputs a feature

$${F}_{d}^{p}$$

with a modified distribution. A residual network function 1806, 1814 is performed in parallel outputs a feature to output

$${F}_{r}^{p} .$$

The two output features are concatenated 1808, 1816 and sent to an MLP 1810, 1818 for a feature with a further modified distribution. One purpose of the MLP is to match the feature dimension to facilitate the cascading. The “mix-then-propagate” process may be repeated several times. Empirically, four iterations may maximize the reconstruction performance and memory efficiency trade-off. Before the last iteration, a residual connection may be added for more stable learning. The symbol F^{g} 1820 represents a group feature.

### Probability Distribution Estimation

A local group of points surrounding each query point may be gathered to collect local geometric information. The input “point feature” is shown in Eq. 8:

$${F}^{p} = {\{ {F}_{jk}^{p} \}}_{j = 1 ... N , k = 1 ... K} ∈ {ℝ}^{N K \times D} \qquad ( 8 )$$

where N is the number of groups, and K is the number of points in a group. These points in groups are then pooled into one feature to become a part of the “group feature” F^{g}. For some embodiments, the term “groups” may be considered as points after downsampling each local group (a set of points near the point). The point feature before the downsampling includes all of the queried local points.

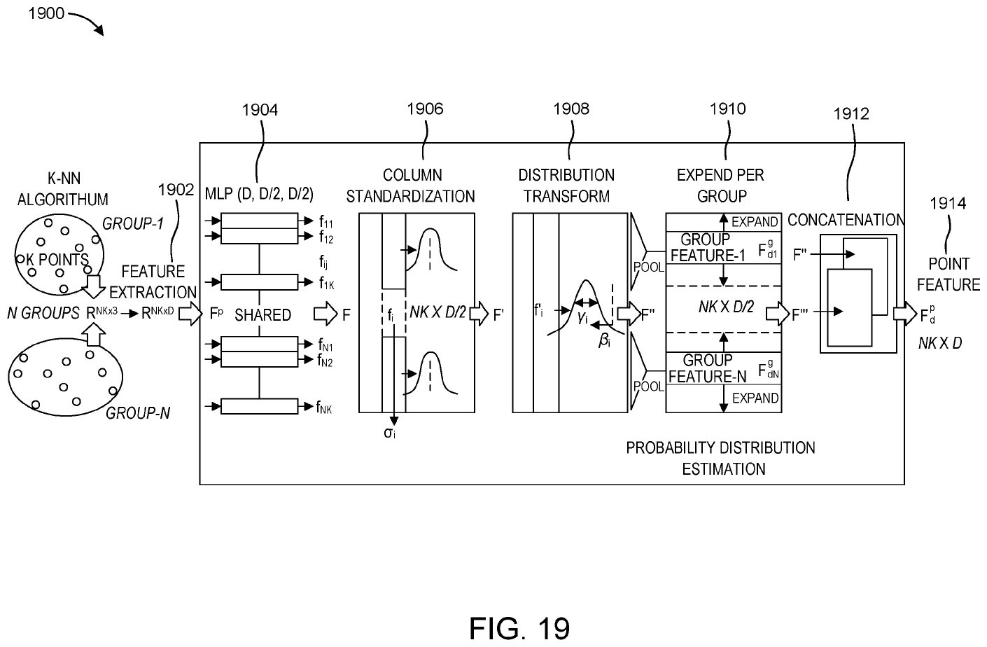

FIG. 19 is a functional block diagram illustrating a probability estimator distribution network according to some embodiments. As illustrated on the left side of FIG. 19, the local grouping and NK point features embedding follow the process of the GRASP-Net architecture, which is described in Pang. In the example PCC framework 1900 of FIG. 19, these local groupings and NK point features are inputs 1902 into the E1 encoder.

In the probability distribution estimation, F^{p} is embedded to a D/2 dimension with a shared MLP 1904 to obtain F. This feature F may be viewed as a set of point features {Fⱼₖ}∈ [symbol] ^{NK×D/2}. For each group j, the corresponding mean feature is computed as shown in Eq. 9:

$$\overline{{F}_{J}} = {\sum }_{k = 1}^{K} \frac{{F}_{jk}}{K} \qquad ( 9 )$$

For each feature row Fⱼₖ, the corresponding group mean F̅ⱼ̅ is subtracted to obtain a recentered feature element as shown in Eq. 10:

$$Δ {F}_{jk} = {F}_{jk} - \overline{{F}_{J}} \qquad ( 10 )$$

A reshaped feature vector (channel-wise vector) is a set of feature elements. Examples of reshaped vectors are fᵢ or

$${f}_{i}^{′}$$

in FIG. 6. A mean value is calculated over these feature elements. The mean value is subtracted from the above feature elements. The standard deviation vector of each column of ΔF, σ∈ [symbol] ^{D}, is computed. The standardized point feature may be formulated as Eq. 11:

$${F}_{jk}^{′} = \frac{Δ {F}_{jk}}{σ + ϵ} \qquad ( 11 )$$

where ϵ is a small value for numerical stability. The set

$${F}_{jk}^{′}$$

for values of j and k forms 1906 the standardized feature F′.

Each standardized i-th column,

$${f}_{i}^{′} ,$$

forms a bell curve centered to a group mean or a query point. These group distributions are sought to be made deformable via learnable transform parameters γ∈ [symbol] ^{D/2} and β∈ [symbol] ^{D/2}. The distribution-transformed point feature

$${F}_{jk}^{″}$$

is computed 1908 with Eq. 12:

$${F}_{jk}^{″} = {γ}^{T} \cdot {F}_{jk}^{′} + β \qquad ( 12 )$$

A pooling operation is processed for each group j, resulting in the group feature of Eq. 13:

$${F}_{d}^{g} = {\{ {F}_{dj}^{g} \}}_{j = 1 ... N} ∈ {ℝ}^{N \times D} \qquad ( 13 )$$

and shown in FIG. 19. For a deeper network, the output feature may further propagate to the next stage's input. In this case, the pooled

$${F}_{d}^{g}$$

is expanded 1910 to match the size of the feature F″ and denoted as F″′. The features are concatenated 1912 and another output point feature

$${F}_{d}^{p}$$

1914 is generated. See FIG. 19.

### Residual Network

In parallel with the probability distribution estimation, a point-wise residual network may be generated for each stage. See FIG. 9 for an example. Based on the ResNet architecture of He, a residual network is designed to fit to the PCC framework. To adapt the network to the point cloud input, the convolution layers are replaced with fully-connected (FC) layers. As indicated in FIG. 9, the feature dimension D may be reduced in half by an FC layer. Similar to the probability distribution estimation process, the residual network also has branching outputs,

$${F}_{r}^{p} and {F}_{r}^{g} .$$

For deeper iteration,

$${F}_{r}^{p}$$

may be used. Otherwise,

$${F}_{r}^{g}$$

may be used for the final aggregation stage. See FIG. 18. For the DDA-Net output, group features are concatenated during the last stage. The final MLP extracts the feature dimension to match the sparse CNN, which is shown as encoder E2 in FIG. 17.

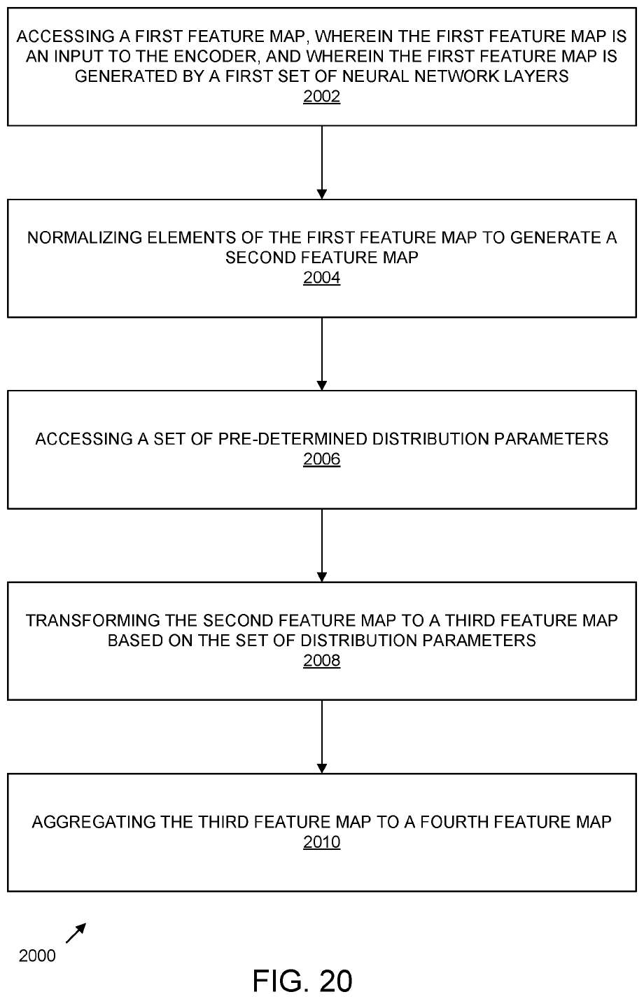

FIG. 20 is a flowchart illustrating an example process for point cloud feature extraction according to some embodiments. For some embodiments, an example learning-based point cloud geometry encoder process may include accessing a first feature map, wherein the first feature map is an input to the encoder, and wherein the first feature map is generated by a first set of neural network layers. For some embodiments, the example process may further include normalizing elements of the first feature map to generate a second feature map. For some embodiments, the example process may further include accessing a set of distribution parameters. For some embodiments, the example process may further include transforming the second feature map to a third feature map based on the set of distribution parameters. For some embodiments, the example process may further include aggregating the third feature map to a fourth feature map.

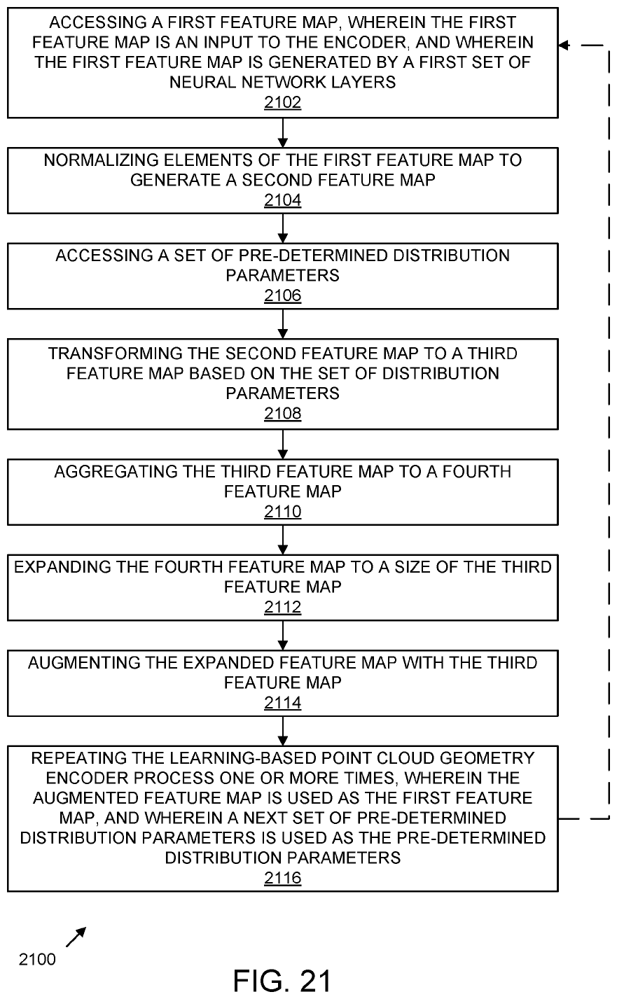

FIG. 21 is a flowchart illustrating an example process for point cloud feature extraction according to some embodiments. For some embodiments, a further example learning-based point cloud geometry encoder process may include accessing a first feature map, wherein the first feature map is an input to the encoder, and wherein the first feature map is generated by a first set of neural network layers. For some embodiments, the further example process may further include normalizing elements of the first feature map to generate a second feature map. For some embodiments, the further example process may further include accessing a set of distribution parameters. For some embodiments, the further example process may further include transforming the second feature map to a third feature map based on the set of distribution parameters. For some embodiments, the further example process may further include aggregating the third feature map to a fourth feature map. For some embodiments, the further example process may further include expanding the fourth feature map to a size of the third feature map. For some embodiments, the further example process may further include augmenting the expanded feature map with the third feature map. For some embodiments, the further example process may further include repeating the learning-based point cloud geometry encoder one or more times, wherein the augmented feature map is used as the first feature map, and wherein a next set of distribution parameters is used as the distribution parameters.

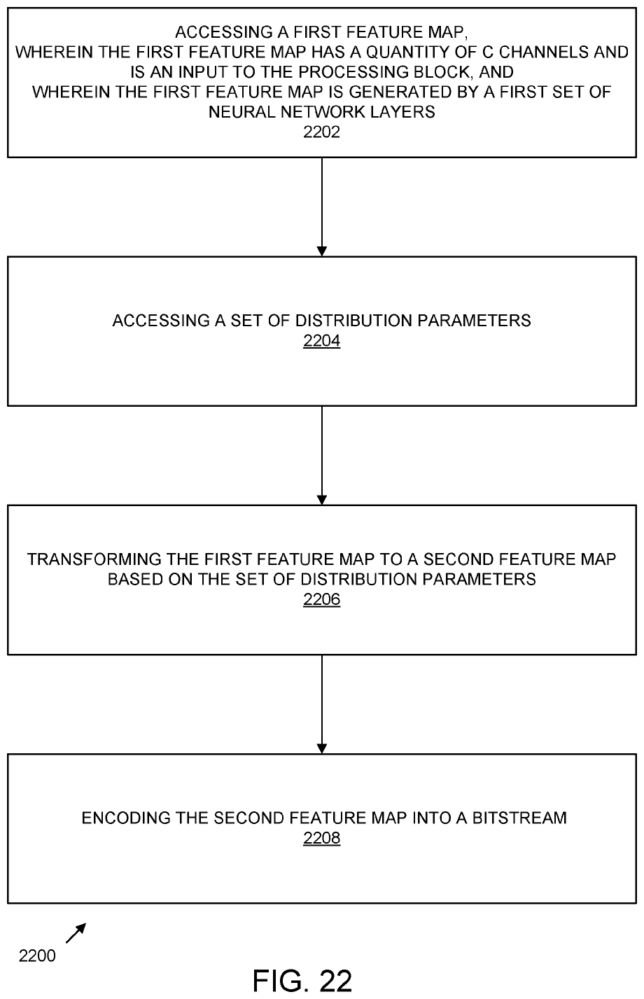

FIG. 22 is a flowchart illustrating an example learning-based point cloud geometry process according to some embodiments. Some embodiments of the example process 2200 may include accessing 2202 a first feature map, wherein the first feature map has a quantity of C channels and is an input to the processing block, and wherein the first feature map is generated by a first set of neural network layers. For some embodiments, the example process may further include accessing 2204 a set of distribution parameters. For some embodiments, the example process may further include transforming 2206 the first feature map to a second feature map based on the set of distribution parameters. For some embodiments, the example process may further include encoding 2208 the second feature map into a bitstream.

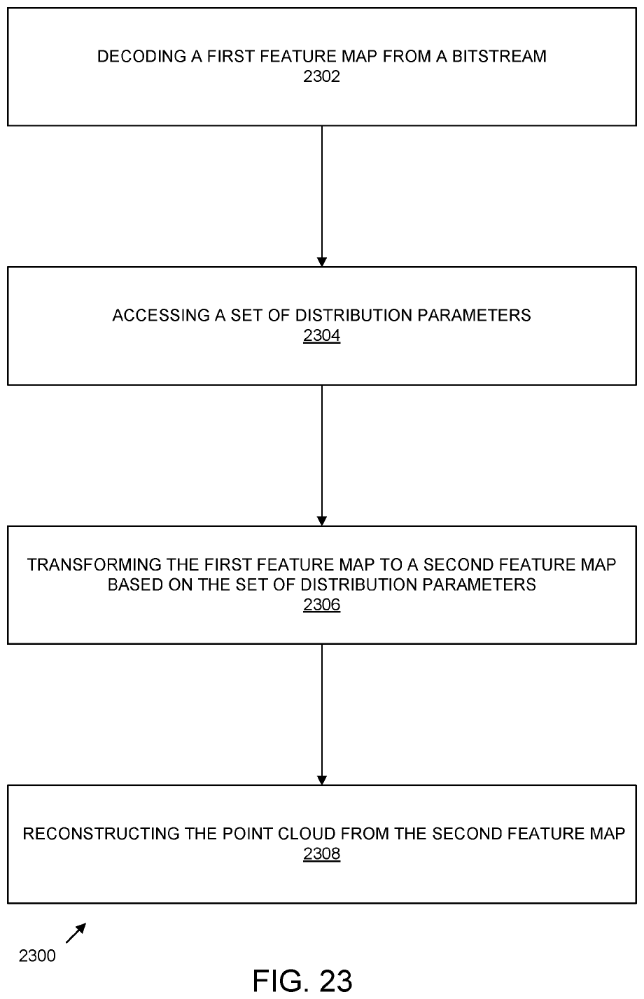

FIG. 23 is a flowchart illustrating an example learning-based point cloud geometry process according to some embodiments. Some embodiments of the example process 2300 may include decoding 2302 a first feature map from a bitstream. For some embodiments, the example process may further include accessing 2304 a set of distribution parameters. For some embodiments, the example process may further include transforming 2306 the first feature map to a second feature map based on the set of distribution parameters. For some embodiments, the example process may further include reconstructing 2308 the point cloud from the second feature map.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

An example learning-based point cloud geometry processing block method in accordance with some embodiments may include: accessing a first feature map, wherein the first feature map has a quantity of C channels and is an input to the processing block, and wherein the first feature map is generated by a first set of neural network layers; accessing a set of distribution parameters; transforming the first feature map to a second feature map based on the set of distribution parameters; and encoding the second feature map into a bitstream,

Some embodiments of the example learning-based point cloud geometry encoding block method may further include updating the first feature map by normalizing elements of the first feature map.

For some embodiments of the example learning-based point cloud geometry encoding block method, normalizing the elements of the first feature map may include: determining a respective length of each feature vector associated with one of the elements of the first feature map; and dividing each element of the first feature map by the respective length.

For some embodiments of the example learning-based point cloud geometry encoding block method, normalizing the elements of the first feature map may include: arranging each of one of more vectors by reshaping an associated feature channel in the first feature map; determining a respective length of each of the one or more vectors for each feature channel; and dividing each vector element of each vector by the respective length for each feature channel, wherein each vector element is one of the elements of the first feature map.

For some embodiments of the example learning-based point cloud geometry encoding block method, normalizing the elements of the first feature map may include: arranging each of one of more vectors by reshaping an associated feature channel in the first feature map; determining a respective standard deviation of each of the one or more vectors for each feature channel; and determining a respective mean of each of the one or more vectors for each feature channel; and updating each vector element of each vector by subtracting the respective mean; and dividing each updated vector element of each vector by the respective standard deviation for each feature channel, wherein each vector element is one of the elements of the first feature map.

For some embodiments of the example learning-based point cloud geometry encoding block method, the set of distribution parameters is determined using a back-propagation technique during a training period.

For some embodiments of the example learning-based point cloud geometry encoding block method, the set of distribution parameters is determined on a per feature channel basis.

Some embodiments of the example learning-based point cloud geometry encoding block method may further include: updating the second feature map by performing downsampling using a function of average pooling or max pooling.

Some embodiments of the example learning-based point cloud geometry encoding block method may further include: determining a third feature map by filtering the second feature map using a smoothing filter; and updating the second feature map by concatenating the third feature map to the second feature map.

For some embodiments of the example learning-based point cloud geometry encoding block method, prior to encoding the second feature map, performing a process may include: accessing a second set of distribution parameters; and updating the second feature map by transforming the second feature map based on the second set of distribution parameters.

For some embodiments of the example learning-based point cloud geometry encoding block method, prior to encoding the second feature map, performing a process may include aggregating the second feature map using a second neural network.

For some embodiments of the example learning-based point cloud geometry encoding block method, the second neural network is selected from the group consisting of a sparse convolutional neural network (CNN) and multi-perceptron layers (MLP).

For some embodiments of the example learning-based point cloud geometry encoding block method, aggregating the second feature map may include using a Residual Network (ResNet) architecture.

Some embodiments of the example learning-based point cloud geometry encoding block method may further include: determining a fourth feature map by aggregating the first feature map using a neural network in parallel to transforming the first feature map to the second feature map; and updating the second feature map by concatenating the fourth feature map to the second feature map.

For some embodiments of the example learning-based point cloud geometry encoding block method, aggregating the first feature map using the neural network may include using a Residual Network (ResNet) architecture.

For some embodiments of the example learning-based point cloud geometry encoding block method, prior to transforming the first feature map to the second feature map, performing a process including aggregating the first feature map using a third neural network.

For some embodiments of the example learning-based point cloud geometry encoding block method, the third neural network is selected from the group consisting of a sparse convolutional neural network (CNN) and multi-perceptron layers (MLP).

An example learning-based point cloud geometry encoding block apparatus in accordance with some embodiments may include: a processor; and a non-transitory computer-readable medium storing instructions operative, when executed by the processor, to cause the apparatus to perform any of the claims listed above

An example learning-based point cloud geometry decoder method in accordance with some embodiments may include: decoding a first feature map from a bitstream; accessing a set of distribution parameters; transforming the first feature map to a second feature map based on the set of distribution parameters; and reconstructing the point cloud from the second feature map.

Some embodiments of the example learning-based point cloud geometry decoder method may further include: updating the first feature map by normalizing elements of the first feature map.

For some embodiments of the example learning-based point cloud geometry decoder method, normalizing the elements of the first feature map may include: determining a respective length of each feature vector associated with one of the elements of the first feature map; and dividing each element of the first feature map by the respective length.

For some embodiments of the example learning-based point cloud geometry decoder method, normalizing the elements of the first feature map may include: arranging each of one of more vectors by reshaping an associated feature channel in the first feature map; determining a respective length of each of the one or more vectors for each feature channel; and dividing each vector element of each vector by the respective length for each feature channel, wherein each vector element is one of the elements of the first feature map.

For some embodiments of the example learning-based point cloud geometry decoder method, normalizing the elements of the first feature map may include: arranging each of one of more vectors by reshaping an associated feature channel in the first feature map; determining a respective standard deviation of each of the one or more vectors for each feature channel; and determining a respective mean of each of the one or more vectors for each feature channel; and updating each vector element of each vector by subtracting the respective mean; and dividing each updated vector element of each vector by the respective standard deviation for each feature channel, wherein each vector element is one of the elements of the first feature map.

For some embodiments of the example learning-based point cloud geometry decoder method, the set of distribution parameters is determined using a back-propagation technique during a training period.

For some embodiments of the example learning-based point cloud geometry decoder method, the set of distribution parameters is determined on a per feature channel basis.

For some embodiments of the example learning-based point cloud geometry decoder method, prior to encoding the second feature map, performing a process including: accessing a second set of distribution parameters; and updating the second feature map by transforming the second feature map based on the second set of distribution parameters.

For some embodiments of the example learning-based point cloud geometry decoder method, prior to encoding the second feature map, performing a process including aggregating the second feature map using a second neural network.

For some embodiments of the example learning-based point cloud geometry decoder method, the second neural network is selected from the group consisting of a sparse convolutional neural network (CNN) and multi-perceptron layers (MLP).

For some embodiments of the example learning-based point cloud geometry decoder method, aggregating the second feature map may include using a Residual Network (ResNet) architecture.

For some embodiments of the example learning-based point cloud geometry decoder method, prior to transforming the first feature map to the second feature map, performing a process including aggregating the first feature map using a third neural network.

For some embodiments of the example learning-based point cloud geometry decoder method, the third neural network is selected from the group consisting of a sparse convolutional neural network (CNN) and multi-perceptron layers (MLP).

An example learning-based point cloud geometry decoder apparatus in accordance with some embodiments may include: a processor; and a non-transitory computer-readable medium storing instructions operative, when executed by the processor, to cause the apparatus to perform any of the methods listed above.

An example method in accordance with some embodiments may include: querying a local point group for each point in a point cloud with a selected group size; extracting a first point-wise feature; and performing a first and second pass through a feedback process, the feedback process including: transforming the first point-wise feature to a second point-wise per-channel distribution feature based on a set of transformation parameters; extracting a third point-wise feature from the second point-wise feature via a deep network; aggregating the third point-wise feature based on the local point group to form a first group-wise feature; augmenting the third point-wise feature with an expanded version of the first group-wise feature; and obtaining a next-stage first point-wise feature to use as the first point-wise feature for the second pass through the feedback process.

For some embodiments of the example method the set of transformation parameters is a set of learnable transformation parameters.

For some embodiments, the example method may further include expanding the first group-wise feature to generate the expanded version of the first group-wise feature.

For some embodiments of the example method the next-stage first point-wise feature may be the augmented third point-wise feature.

For some embodiments, the example method may further include: aggregating the second point-wise feature based on the local point group to form a second group-wise feature; augmenting the second point-wise feature with an expanded version of the second group-wise feature to form an updated second point-wise feature; obtaining a fourth point-wise feature; and matching the updated second point-wise feature with the fourth point-wise feature.

For some embodiments, the example method may further include expanding the third point-wise feature to generate the expanded version of the second group-wise feature.

For some embodiments of the example method a latent code may include the third point-wise feature.

For some embodiments of the example method a set abstraction feature may include the second group-wise feature.

An example apparatus in accordance with some embodiments may include: a processor; and a non-transitory computer-readable medium storing instructions operative, when executed by the processor, to cause the apparatus to: query a local point group for each point in a point cloud with a selected group size; extract a first point-wise feature; and perform a first and second pass through a feedback process, the instructions further operative, when executed by the processor, to execute the feedback process and cause the apparatus to: transform the first point-wise feature to a second point-wise per-channel distribution feature based on a set of transformation parameters; extract a third point-wise feature from the second point-wise feature via a deep network; aggregate the third point-wise feature based on the local point group to form a first group-wise feature; augment the third point-wise feature with an expanded version of the first group-wise feature; and obtain a next-stage first point-wise feature to use as the first point-wise feature for the second pass through the feedback process.

An additional example method in accordance with some embodiments may include: querying a local point group for each point in a point cloud with a selected group size; extracting a first point-wise feature; and performing a first and second pass through a feedback process, the feedback process including: extracting a second point-wise feature from the first point-wise feature via a residual-based network; aggregating the second point-wise feature based on the local point group to form a first group-wise feature; transforming the first point-wise feature to a third point-wise per-channel distribution feature based on a set of transformation parameters; extracting a fourth point-wise feature from the third point-wise feature via a deep network; aggregating the fourth point-wise feature based on the local point group to form a second group-wise feature; augmenting the second point-wise feature with an expanded version of the first group-wise feature to form a next-stage first point-wise feature to use as the first point-wise feature for the second pass through the feedback process; and augmenting the fourth point-wise feature with an expanded version of the second group-wise feature to form a next-stage third point-wise feature to use as the third point-wise feature for the second pass through the feedback process.

For some embodiments of the additional example method, the set of transformation parameters may be a set of learnable transformation parameters.

For some embodiments, the additional example method may further include expanding the first group-wise feature to generate the expanded version of the first group-wise feature.

For some embodiments, the additional example method may further include expanding the second group-wise feature to generate the expanded version of the second group-wise feature.

For some embodiments, the additional example method may further include: extracting a fifth point-wise feature; transforming the fifth point-wise feature to a sixth point-wise per-channel feature distribution based on a second set of transformation parameters; and extracting a seventh point-wise feature from the sixth point-wise feature via a second residual-based network.

For some embodiments of the additional example method, the second set of transformation parameters may be a second set of learnable transformation parameters.

For some embodiments, the additional example method may further include outputting the seventh point-wise feature.

For some embodiments of the additional example method, a latent code may include at least one of the first point-wise feature and the third point-wise feature.

For some embodiments of the additional example method, a set abstraction feature may include at least one of the first point-wise feature and the third point-wise feature.

An additional example apparatus in accordance with some embodiments may include: a processor; and a non-transitory computer-readable medium storing instructions operative, when executed by the processor, to cause the apparatus to: query a local point group for each point in a point cloud with a selected group size; extract a first point-wise feature; and perform a first and second pass through a feedback process, the instructions further operative, when executed by the processor, to execute the feedback process and cause the apparatus to: extract a second point-wise feature from the first point-wise feature via a residual-based network; aggregate the second point-wise feature based on the local point group to form a first group-wise feature; transform the first point-wise feature to a third point-wise per-channel distribution feature based on a set of transformation parameters; extract a fourth point-wise feature from the third point-wise feature via a deep network; aggregate the fourth point-wise feature based on the local point group to form a second group-wise feature; augment the second point-wise feature with an expanded version of the first group-wise feature to form a next-stage first point-wise feature to use as the first point-wise feature for the second pass through the feedback process; and augment the fourth point-wise feature with an expanded version of the second group-wise feature to form a next-stage third point-wise feature to use as the third point-wise feature for the second pass through the feedback process.

A further example method in accordance with some embodiments may include: querying a local point group for each point in a point cloud with a selected group size; extracting a first point-wise feature; transforming the first point-wise feature to a second point-wise per-channel distribution feature based on a set of transformation parameters; extracting a third point-wise feature from the second point-wise feature via a deep network; aggregating the third point-wise feature based on the local point group to form a first group-wise feature; and extracting a second group-wise feature from an expanded version of the first group-wise feature.

For some embodiments of the further example method, the set of transformation parameters may be a set of learnable transformation parameters.

For some embodiments, the further example method may further include expanding the first group-wise feature to generate the expanded version of the first group-wise feature.

For some embodiments, the further example method may further include outputting the second group-wise feature.

For some embodiments, the further example method may further include: extracting a fourth point-wise feature from the first point-wise feature via a residual-based network; aggregating the fourth point-wise feature based on the local point group to form a third group-wise feature; and extracting a fourth group-wise feature from an expanded version of the third group-wise feature.

For some embodiments, the further example method may further include expanding the third group-wise feature to generate the expanded version of the third group-wise feature.

For some embodiments of the further example method, a latent code may include the second group-wise feature.

For some embodiments of the further example method, a set abstraction feature may include the second group-wise feature.

A further example apparatus in accordance with some embodiments may include: a processor; and a non-transitory computer-readable medium storing instructions operative, when executed by the processor, to cause the apparatus to: query a local point group for each point in a point cloud with a selected group size; extract a first point-wise feature; transform the first point-wise feature to a second point-wise per-channel distribution feature based on a set of transformation parameters; extract a third point-wise feature from the second point-wise feature via a deep network; aggregate the third point-wise feature based on the local point group to form a first group-wise feature; and extract a second group-wise feature from an expanded version of the first group-wise feature.

For some embodiments of the further example apparatus, the instructions may be further operative, when executed by the processor, to cause the apparatus to: extract a fourth point-wise feature from the first point-wise feature via a residual-based network; aggregate fourth point-wise feature based on the local point group to form a third group-wise feature; and extract a fourth group-wise feature from an expanded version of the third group-wise feature.

A further additional example method in accordance with some embodiments may include: extracting a first group-wise feature; expanding the first group-wise feature to a first point-wise feature; transforming the first point-wise feature to a second point-wise per-channel distribution feature based on a set of transformation parameters; extracting a third point-wise feature from the second point-wise feature via a deep network; and extracting a fourth point-wise feature from the third point-wise feature.

A further additional example apparatus in accordance with some embodiments may include: one or more processors; and at least one memory coupled to the one or more processors, wherein the one or more processors are configured to perform any one of the methods listed above.

An example signal in accordance with some embodiments may include: a bitstream, formed by performing any one of the methods listed above.

An example computer readable storage medium in accordance with some embodiments may have stored thereon instructions for encoding or decoding a point cloud according to any one of the methods listed above.

An example learning-based point cloud geometry processing block method in accordance with some embodiments may include: accessing a first feature map, wherein the first feature map is an input to the processing block, and wherein the first feature map is generated by a first set of neural network layers; normalizing elements of the first feature map to generate a second feature map; accessing a set of distribution parameters; transforming the second feature map to a third feature map based on the set of distribution parameters; and aggregating the third feature map to a fourth feature map.

For some embodiments of the example learning-based point cloud geometry processing block method, the first feature map is a local group queried point-wise feature map.

For some embodiments of the example learning-based point cloud geometry processing block method, the second feature map is a concatenation of per-slice feature elements, computed by standardizing the corresponding slice from the first feature map.

For some embodiments of the example learning-based point cloud geometry processing block method, the set of distribution parameters is obtained via training.

For some embodiments of the example learning-based point cloud geometry processing block method, the set of distribution parameters are defined and applied per slice.

For some embodiments of the example learning-based point cloud geometry processing block method, the fourth feature map is a concatenation of per local-group feature aggregation to generate a group-wise feature map.

For some embodiments of the example learning-based point cloud geometry processing block method, the fourth feature map is encoded into a bitstream.

Some embodiments of the example learning-based point cloud geometry processing block method may further include: expanding the fourth feature map to a size of the third feature map; augmenting the expanded feature map with the third feature map; and repeating the learning-based point cloud geometry encoder method of claim 34 one or more times, wherein the augmented feature map is used as the first feature map, and wherein a next set of distribution parameters is used as the distribution parameters.

For some embodiments of the example learning-based point cloud geometry processing block method, the next set of distribution parameters is obtained via training.

For some embodiments of the example learning-based point cloud geometry processing block method, the next set of distribution parameters is defined for each repeat of the learning-based point cloud geometry encoder method of a previous claim.

For some embodiments of the example learning-based point cloud geometry processing block method, the third feature map is a point-wise feature map.

For some embodiments of the example learning-based point cloud geometry processing block method, the fourth feature map is a group-wise feature map.

For some embodiments of the example learning-based point cloud geometry processing block method, the third feature map is a fine feature map.

For some embodiments of the example learning-based point cloud geometry processing block method, the fourth feature map is a coarse feature map.

Some embodiments of the example learning-based point cloud geometry processing block method may further include connecting a residual network in parallel to the learning-based point cloud geometry encoder.

Some embodiments of the example learning-based point cloud geometry processing block method may further include connecting a residual network in series to the learning-based point cloud geometry encoder.

Some embodiments of the example learning-based point cloud geometry processing block method may further include: inputting the fourth feature map into a second set of neural network layers; and encoding an output of the second set of neural network layers into a bitstream.

An example learning-based point cloud geometry processing block apparatus in accordance with some embodiments may include: a processor; and a non-transitory computer-readable medium storing instructions operative, when executed by the processor, to cause the apparatus to perform a method listed above.

An example learning-based point cloud geometry decoder method in accordance with some embodiments may include: accessing a first feature map, wherein the first feature map is an input, and wherein the first feature map is decoded from a bitstream; expanding the first feature map to a second feature map; normalizing elements of the second feature map to generate a third feature map; accessing a set of distribution parameters; and transforming the third feature map to a fourth feature map based on the set of distribution parameters.

For some embodiments of the example learning-based point cloud geometry decoder method, expanding the first feature map to the second feature map may include unpooling the first feature map to the second feature map.

For some embodiments of the example learning-based point cloud geometry decoder method, the first feature map is a decoded group-wise feature map.

For some embodiments of the example learning-based point cloud geometry decoder method, the second feature map is generated by a first set of neural network layers.

For some embodiments of the example learning-based point cloud geometry decoder method, the second feature map is expanded to a size of a point-wise feature map.

For some embodiments of the example learning-based point cloud geometry decoder method, the third feature map is a concatenation of per-slice feature elements, and the third feature map is computed by standardizing a corresponding slice from the second feature map.

For some embodiments of the example learning-based point cloud geometry decoder method, at least one of the corresponding slices is further divided into two or more groups.

For some embodiments of the example learning-based point cloud geometry decoder method, the set of distribution parameters is obtained via training.

For some embodiments of the example learning-based point cloud geometry decoder method, the fourth feature map is inputted into a second set of neural network layers to reconstruct a point cloud.

Some embodiments of the example learning-based point cloud geometry decoder method may further include: embedding the fourth feature map via a set of neural network layers; repeating the learning-based point cloud geometry decoder method one or more times, wherein the embedded feature map is used as the second feature map, and wherein a next set of distribution parameters is used as the distribution parameters.

For some embodiments of the example learning-based point cloud geometry decoder method, the next set of distribution parameters is obtained via training.

For some embodiments of the example learning-based point cloud geometry decoder method, the next set of distribution parameters is defined for each repeat of the learning-based point cloud geometry decoder method.

Some embodiments of the example learning-based point cloud geometry decoder method may further include: aggregating the fourth feature map to a fifth feature map; expanding the fifth feature map to a size of the fourth feature map; augmenting the expanded feature map with the fourth feature map; repeating the learning-based point cloud geometry decoder method of claim 84 one or more times, wherein the augmented feature map is used as the second feature map, and wherein a next set of distribution parameters is used as the distribution parameters.

For some embodiments of the example learning-based point cloud geometry decoder method, the next set of distribution parameters is obtained via training.

For some embodiments of the example learning-based point cloud geometry decoder method, the next set of distribution parameters is defined for each repeat of the learning-based point cloud geometry decoder method of claim 84.

For some embodiments of the example learning-based point cloud geometry decoder method, the fourth feature map is a point-wise feature map.

For some embodiments of the example learning-based point cloud geometry decoder method, the fifth feature map is a group-wise feature map.

For some embodiments of the example learning-based point cloud geometry decoder method, the fourth feature map is a fine feature map.

For some embodiments of the example learning-based point cloud geometry decoder method, the fifth feature map is a coarse feature map.

Some embodiments of the example learning-based point cloud geometry decoder method may further include connecting a residual network in parallel to the learning-based point cloud geometry decoder.

Some embodiments of the example learning-based point cloud geometry decoder method may further include connecting a residual network in series to the learning-based point cloud geometry decoder.

An example learning-based point cloud geometry decoder apparatus in accordance with some embodiments may include: a processor; and a non-transitory computer-readable medium storing instructions operative, when executed by the processor, to cause the apparatus to perform one of the methods listed above.

For some embodiments of the example learning-based point cloud geometry processing block method, at least one of the distribution parameters is pre-determined.

An example method in accordance with some embodiments may include: querying a local point group for each point in a point cloud with a selected group size; extracting a first point-wise feature; and performing a process including: transforming the first point-wise feature to a second point-wise feature according to a per-channel distribution specified by a set of transformation parameters; extracting a third point-wise feature from the second point-wise feature via neural network layers; aggregating the third point-wise feature based on the local point group to form a first group-wise feature; augmenting the third point-wise feature with an expanded version of the first group-wise feature; and obtaining a next-stage first point-wise feature to use as the first point-wise feature for a next stage process.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

The aspects described and contemplated in this disclosure can be implemented in many different forms. While some embodiments are illustrated specifically, other embodiments are contemplated, and the discussion of particular embodiments does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present disclosure, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

The terms HDR (high dynamic range) and SDR (standard dynamic range) often convey specific values of dynamic range to those of ordinary skill in the art. However, additional embodiments are also intended in which a reference to HDR is understood to mean “higher dynamic range” and a reference to SDR is understood to mean “lower dynamic range.” Such additional embodiments are not constrained by any specific values of dynamic range that might often be associated with the terms “high dynamic range” and “standard dynamic range.”

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

Various implementations involve decoding. “Decoding”, as used in this disclosure, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this disclosure, for example, extracting a picture from a tiled (packed) picture, determining an upsampling filter to use and then upsampling a picture, and flipping a picture back to its intended orientation.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions.

Various implementations involve encoding. In an analogous way to the above discussion about “decoding”, “encoding” as used in this disclosure can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this disclosure.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. A mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Also, as used herein, the word “signal” refers to, among other things, indicating something to a corresponding decoder. For example, in certain embodiments the encoder signals a particular one of a plurality of parameters for region-based filter parameter selection for de-artifact filtering. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
Adapting residues at an encoder according to any of the embodiments discussed.
A bitstream or signal that includes one or more of the described syntax elements, or variations thereof.
A bitstream or signal that includes syntax conveying information generated according to any of the embodiments described.
Inserting in the signaling syntax elements that enable the decoder to adapt residues in a manner corresponding to that used by an encoder.
Creating and/or transmitting and/or receiving and/or decoding a bitstream or signal that includes one or more of the described syntax elements, or variations thereof.
Creating and/or transmitting and/or receiving and/or decoding according to any of the embodiments described.
A method, process, apparatus, medium storing instructions, medium storing data, or signal according to any of the embodiments described.
A TV, set-top box, cell phone, tablet, or other electronic device that performs adaptation of filter parameters according to any of the embodiments described.
A TV, set-top box, cell phone, tablet, or other electronic device that performs adaptation of filter parameters according to any of the embodiments described, and that displays (e.g. using a monitor, screen, or other type of display) a resulting image.
A TV, set-top box, cell phone, tablet, or other electronic device that selects (e.g. using a tuner) a channel to receive a signal including an encoded image, and performs adaptation of filter parameters according to any of the embodiments described.
A TV, set-top box, cell phone, tablet, or other electronic device that receives (e.g. using an antenna) a signal over the air that includes an encoded image, and performs adaptation of filter parameters according to any of the embodiments described.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A learning-based point cloud geometry processing block method, the method comprising:
accessing a first feature map,
wherein the first feature map has a quantity of C channels and is an input to the processing block, and
wherein the first feature map is generated by a first set of neural network layers;
accessing a set of distribution parameters; and
transforming the first feature map to a second feature map based on the set of distribution parameters.

2. The method of claim 1, further comprising updating the first feature map by normalizing vector elements of the first feature map.

3. The method of claim 2, wherein normalizing the vector elements of the first feature map comprises:
determining a respective length of each feature vector associated with one of the vector elements of the first feature map; and
dividing each of the vector elements of the first feature map by the respective length.

4. The method of claim 2, wherein normalizing the vector elements of the first feature map comprises:
arranging vectors by reshaping each associated feature channel in the first feature map;
determining a respective length of each reshaped vector for each feature channel; and
dividing each of the vector elements of each reshaped vector by the respective length for each feature channel,
wherein each vector element is one of the elements of the first feature map.

5. The method of claim 2, wherein normalizing the vector elements of the first feature map comprises:
arranging vectors by reshaping each associated feature channel in the first feature map;
determining a respective standard deviation of each reshaped vector for each feature channel; and
determining a respective mean of each reshaped vector for each feature channel; and
updating each vector element of each vector by subtracting the respective mean; and
dividing each updated vector element of each vector by the respective standard deviation for each feature channel,
wherein each vector element is one of the elements of the first feature map.

6. The method of claim 1, wherein the set of distribution parameters is determined using a back-propagation technique during a training period.

7. The method of claim 1, wherein the set of distribution parameters is determined on a per feature channel basis.

8. The method of claim 1, further comprising updating the second feature map by performing downsampling using a function of average pooling or max pooling.

9. The method of claim 1, further comprising:
determining a third feature map by filtering the second feature map using a smoothing filter; and
updating the second feature map by concatenating the third feature map to the second feature map.

10. The method of claim 1, further comprising:
accessing a second set of distribution parameters; and
updating the second feature map by transforming the second feature map based on the second set of distribution parameters; and
encoding the second feature map into a bitstream.

11. The method of claim 1, further comprising:
aggregating the feature map using a second neural network; and
encoding the second feature map into a bitstream.

12. The method of claim 11, wherein the second neural network is selected from the group consisting of a sparse convolutional neural network (CNN) and multi-perceptron layers (MLP).

13. The method of claim 11, wherein aggregating the second feature map comprises using a Residual Network (ResNet) architecture.

14. The method of claim 1, further comprising:
determining a fourth feature map by aggregating the first feature map using a neural network in parallel to transforming the first feature map to the second feature map; and
updating the second feature map by concatenating the fourth feature map to the second feature map.

15-17. (canceled)

18. An apparatus comprising:
a processor; and
a non-transitory computer-readable medium storing instructions operative, when executed by the processor, to cause the apparatus to:
access a first feature map,
wherein the first feature map has a quantity of C channels and is an input to the processing block, and
wherein the first feature map is generated by a first set of neural network layers;
access a set of distribution parameters; and
transform the first feature map to a second feature map based on the set of distribution parameters.

19. A learning-based point cloud geometry decoder method, the method comprising:
decoding a first feature map from a bitstream;
accessing a set of distribution parameters;
transforming the first feature map to a second feature map based on the set of distribution parameters; and
reconstructing the point cloud from the second feature map.

20. The method of claim 19, further comprising updating the first feature map by normalizing elements of the first feature map.

21. The method of claim 20, wherein normalizing the elements of the first feature map comprises:
determining a respective length of each feature vector associated with one of the elements of the first feature map; and
dividing each element of the first feature map by the respective length.

22. The method of claim 20, wherein normalizing the elements of the first feature map comprises:
arranging each of one of more vectors by reshaping an associated feature channel in the first feature map;
determining a respective length of each of the one or more vectors for each feature channel; and
dividing each vector element of each vector by the respective length for each feature channel,
wherein each vector element is one of the elements of the first feature map.

23. The method of claim 20, wherein normalizing the elements of the first feature map comprises:
arranging each of one of more vectors by reshaping an associated feature channel in the first feature map;
determining a respective standard deviation of each of the one or more vectors for each feature channel; and
determining a respective mean of each of the one or more vectors for each feature channel; and
updating each vector element of each vector by subtracting the respective mean; and
dividing each updated vector element of each vector by the respective standard deviation for each feature channel,
wherein each vector element is one of the elements of the first feature map.

24-107. (canceled)
